(19) United States
(12) Patent Application Publication
(10) Pub. No.: US 2010/0211844 A1
(43) Pub. Date: Aug. 19, 2010

(54) WIRELESS COMMUNICATION APPARATUS, WIRELESS COMMUNICATION SYSTEM, AND WIRELESS COMMUNICATION METHOD

(75) Inventors: Yasuaki Yuda, Kanagawa (JP); Masayuki Hoshino, Kanagawa (JP); Katsuhiko Hiramatsu, Kanagawa (JP); Atsushi Sumasu, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/679,726

(22) PCT Filed: Sep. 24, 2008
(86) PCT No.: PCT/JP2008/002645

§ 371 Date: Mar. 24, 2010

(30) Foreign Application Priority Data
Sep. 27, 2007 (JP) P2007-252362

(51) Int. Cl. H04L 1/18; G06F 11/14

(52) U.S. Cl. 714/749; 714/750; 714/E11.113

(57) ABSTRACT

Lowering of the frequency use efficiency and throughput is prevented while the blanking advantage is provided at the retransmission time in MCW using a plurality of streams per codeword. In a wireless communication apparatus for using a plurality of streams per codeword and performing data transmission according to a plurality of codewords, when two codewords are transmitted using four streams, for example, from a base station 101 to a user terminal 102, if retransmission occurs in the codeword, the codewords and the streams are arranged so as to decrease the number of streams with the number of codewords intact so that retransmission codeword is transmitted in two streams and new codeword is transmitted in one stream.

### TECHNICAL FIELD

This invention relates to a wireless communication apparatus, a wireless communication system, and a wireless communication method that can be applied to MIMO (Multiple Input Multiple Output), etc., for conducting communications using a plurality of antennas.

### BACKGROUND ART

A packet transmission system using HARQ (Hybrid Automatic Retransmission reQuest) using coding and a retransmission technology in combination is discussed as a communication system for realizing high-speed data transmission in 3GPP (3rd Generation Partnership Project) of an international standardization organization of mobile communications, etc. As a system for realizing higher-speed and larger-capacity data transmission, attention is focused on space division multiplexing (SDM) transmission, one of MIMO transmission. The MIMO transmission is a technology of transmitting a signal using a plurality of antennas in both transmission and reception, and the SDM transmission is a technology of spatially multiplexing different signals (streams) using a plurality of antennas. Using the SDM transmission, the frequency use efficiency can be increased without enlarging the time or frequency resources.

In SDM, HARQ and AMC (Adaptive Modulation and Coding) for adaptively controlling a modulation system and coding rate (MCS: Modulation and Coding Scheme) are applied for each stream, whereby the frequency use efficiency can be further improved. In HARQ, Ack (Acknowledgement)/Nack (Negative Acknowledgement) indicating whether or not a transmission packet can be transmitted with no error is fed back from a reception party to a transmission party and if Nack indicating occurrence of an error is detected, data is retransmitted from the transmission party. At this time, the retransmission data may be the same data as the data at the first transmission time or may be data not transmitted at the first transmission time with a redundant bit after coding of the transmission data. The descriptions of retransmission data are sent using Redundancy Version (RV), etc. In AMC, CQI (Channel Quality Indicator) indicating the reception quality is fed back from a reception party to a transmission party and the transmission party selects MCS responsive to the fed-back CQI. A data series of a control unit of HARQ or MCS is called codeword (CW) and a transmission method using a plurality of codewords for controlling codeword for each stream is called MCW (Multiple Codeword).

In MCW for performing HARQ control and AMC for each stream as described above, HARQ control information and AMC control information need to be sent and fed back for each stream. The HARQ control information includes Ack/Nack of the error detection result and Redundancy Version indicating the descriptions of retransmission data, and the AMC control information includes CQI feedback, MCS, etc. In such MCW, if the number of transmission streams increases, the control information increases, the overhead in the line increases, and the frequency use efficiency is lowered. To suppress the overhead caused by the control information, MCW for decreasing the number of codewords controlling HARQ and AMC and using a plurality of streams per codeword is discussed. For example, in a method using two codewords at the transmission time of four streams, MCW using two streams per codeword, etc., exists.

The codeword indicates a coded bit sequence of a control unit of MCS, and the stream indicates a signal sequence transmitted in each antenna and beam subjected to spatial multiplexing in SDM.

As a related art of the HARQ system in MCW, Blanking (which will be hereinafter described as blanking) as shown in Non-patent Document 1. The blanking is the following technology: FIG. 27 is a drawing to describe blanking processing for each codeword in MCW. FIG. 27 shows processing wherein two streams for each code word, four streams in total are transmitted with two codewords of CW1 and CW2 from a base station (BS) 2701 of a transmission apparatus to a user terminal (UE: User Equipment) 2702 of a reception apparatus and Ack/Nack of each stream is fed back from the user terminal 2702 to the base station 2701. FIG. 27 (A) shows the case where no reception error occurs and retransmission does not occur and blanking is not performed and (B) shows the case where a reception error occurs in the stream, Nack is determined, retransmission occurs in one codeword, and blanking is performed.

First, at the first transmission time, each codeword is transmitted from each antenna. If an error occurs in a plurality of codewords (FIG. 27 (B)), only the codeword where the error occurred (retransmission CW) is retransmitted. In this case, the retransmission codeword is transmitted in two streams. At this time, the codeword with no error is set to transmission OFF and a new codeword is not transmitted. Thus, the technology of retransmitting only the codeword where the error occurs without transmitting a new codeword until an error is included in none of spatial-multiplexed codewords is blanking.

Since an error occurs independently in each codeword of MCW, if the number of codewords increases, an error occurs at a high probability. For example, assuming that target PER (Packet Error Rate) of the MCS selection criterion of each codeword is 20%, the probability that an error will occur in at least one codeword becomes 36% if the number of codewords is two; 59% if the number of codewords is four. Target PER=20% is a general value used in a system using HARQ. Thus, if retransmission occurs at a high probability and blanking frequently occurs, the number of multiplexed codewords decreases and new data is not transmitted and therefore the frequency use efficiency and the throughput are lowered.

Non-patent Document 1: 3GPP TSG RAN WG1 #44, R1-060459, QUALCOMM Europe, “Implications of MCW MIMO on DL HARQ”, February, 2006.

### DISCLOSURE OF THE INVENTION

### Problems to be Solved by the Invention

As described above, in MCW using a plurality of streams per codeword, if blanking frequently occurs at the retransmission control time, the number of multiplexed codewords decreases and new data is not transmitted and therefore the frequency use efficiency and the throughput are lowered; this is a problem.

In view of the circumstances described above, it is an object of the invention to provide a wireless communication apparatus, a wireless communication system, and a wireless communication method that can prevent lowering of the frequency use efficiency and throughput while providing the blanking advantage at the retransmission time in MCW using a plurality of streams per codeword.

### Means for Solving the Problems

According to a first aspect of the invention, there is provided a wireless communication apparatus for using a plurality of streams per codeword and performing data transmission according to a plurality of codewords, the wireless communication apparatus comprising: a feedback information reception section that receives feedback information from a communicating station; an Ack/Nack detection section that detects Ack/Nack information corresponding to a reception result of the plurality of codewords contained in the feedback information; a codeword-stream arrangement determination section that determines an arrangement of the codewords and the streams so as to decrease the number of streams while keeping the number of codewords in response to the presence or absence of Nack of the Ack/Nack information when retransmission occurs; and a transmission processing section that performs a transmission processing in response to the arrangement of the codewords and the streams.

Accordingly, while the blanking advantage is provided at the retransmission time, the number of codewords to be multiplexed is ensured and new data can be transmitted, so that it is made possible to prevent lowering of the frequency use efficiency and throughput.

According to a second aspect of the invention, in the wireless communication apparatus in the first aspect of the invention, the codeword-stream arrangement determination section decreases the number of streams of a new codeword in the arrangement of the number of streams.

Accordingly, a large number of streams of retransmission codeword are arranged and a small number of streams of new codeword are arranged, whereby retransmission can be early dissolved, so that it is made possible to further suppress lowering of the frequency use efficiency.

According to a third aspect of the invention, in the wireless communication apparatus in the first aspect of the invention, the codeword-stream arrangement determination section decreases the number of streams of a retransmission codeword in the arrangement of the number of streams.

Accordingly, a large number of streams of new codeword are arranged and a small number of streams of retransmission codeword are arranged, whereby new data can be much transmitted, so that it is made possible to further suppress lowering of the frequency use efficiency.

According to a fourth aspect of the invention, in the wireless communication apparatus in the first aspect of the invention, the codeword-stream arrangement determination section has a table indicating an arrangement relationship between the codewords and the streams in each retransmission situation together with the communicating station and determines the arrangement of the codewords and the streams based on the table.

Accordingly, the table indicating the arrangement relationship between the codewords and the streams is used and appropriate arrangement of the codewords and the streams can be set in each retransmission situation of the presence or absence of retransmission, etc.

According to a fifth aspect of the invention, in the wireless communication apparatus in the first aspect of the invention, the codeword-stream arrangement determination section determines the number of streams of retransmission codeword in response to an error factor of codeword where the retransmission occurs.

Accordingly, the number of data pieces required for retransmission codeword can be controlled in response to the error factor, so that it is made possible to further suppress lowering of the frequency use efficiency.

According to a sixth aspect of the invention, the wireless communication apparatus in the fifth aspect of the invention includes a number-of-retransmission-codeword-streams determination section that determines the number of streams of retransmission codeword in response to an error factor of the codeword when the retransmission occurs.

According to a seventh aspect of the invention, in the wireless communication apparatus in the sixth aspect of the invention, the number-of-retransmission-codeword-streams determination section determines an error occurring at random or an error caused by degradation in reception situation as the error factor based on reception quality information contained in the feedback information and determines the number of streams of the retransmission codeword.

According to an eighth aspect of the invention, in the wireless communication apparatus in the first aspect of the invention, the codeword-stream arrangement determination section determines an arrangement of a transmission stream of each codeword and a blanking stream for performing blanking with transmission OFF in response to a rank of ordering based on reception quality of the plurality of streams.

Accordingly, the stream ordering is used, whereby fitted streams in response to the reception situation can be arranged in the blanking stream and the transmission stream, so that the preventing effect of lowering of the frequency use efficiency can be further improved.

According to a ninth aspect of the invention, the wireless communication apparatus in the eighth aspect of the invention includes an ordering information acquisition section that acquires ordering information representing the rank of ordering of the plurality of streams. The codeword-stream arrangement determination section determines the arrangement of the codewords and the streams based on the ordering information.

According to a tenth aspect of the invention, in the wireless communication apparatus in the first aspect of the invention, the codeword-stream arrangement determination section determines the arrangement of a transmission stream of each codeword and a blanking stream for performing blanking with transmission OFF in response to an error factor of the codeword where the retransmission occurs and a rank of ordering based on reception quality of the plurality of streams.

Accordingly, the number of data pieces required for retransmission codeword can be controlled and fitted streams in response to the reception situation can be arranged in the blanking stream and the transmission stream, so that it is made possible to further suppress lowering of the frequency use efficiency.

According to an eleventh aspect of the invention, the wireless communication apparatus in the tenth aspect of the invention includes a number-of-retransmission-codeword-streams determination section that determines the number of streams of retransmission codeword in response to the error factor of the codeword when the retransmission occurs, and an ordering information acquisition section that acquires ordering information representing the rank of ordering of the plurality of streams. The codeword-stream arrangement determination section determines the arrangement of the codewords and the streams based on the ordering information and the number of streams of retransmission codeword which is determined in response to the error factor.

According to a twelfth aspect of the invention, there is provided a wireless communication apparatus for using a plurality of streams per codeword and performing data transmission according to a plurality of codewords, the wireless communication apparatus includes a control information acquisition section that acquires control information from a communicating station; a codeword-stream arrangement determination section that determines an arrangement of the codewords and the streams so as to decrease the number of streams while keeping the number of codewords based on the control information when retransmission occurs; a reception processing section that performs a reception processing in response to the arrangement of the codewords and the streams; and a feedback information transmission section that transmits feedback information having a response signal corresponding to a reception result of the plurality of codewords.

Accordingly, while the blanking advantage is provided at the retransmission time, the number of codewords to be multiplexed is ensured and new data can be transmitted from the communicating station, so that it is made possible to prevent lowering of the frequency use efficiency and throughput.

According to a thirteenth aspect of the invention, in the wireless communication apparatus in the twelfth aspect of the invention, the codeword-stream arrangement determination section decreases the number of streams of a new codeword in the arrangement of the number of streams.

Accordingly, a large number of streams of retransmission codeword are arranged and a small number of streams of new codeword are arranged, whereby retransmission can be early dissolved, so that it is made possible to further suppress lowering of the frequency use efficiency.

According to a fourteenth aspect of the invention, in the wireless communication apparatus in the twelfth aspect of the invention, the codeword-stream arrangement determination section decreases the number of streams of a retransmission codeword in the arrangement of the number of streams.

Accordingly, a large number of streams of new codeword are arranged and a small number of streams of retransmission codeword are arranged, whereby new data can be much transmitted, so that it is made possible to further suppress lowering of the frequency use efficiency.

According to a fifteenth aspect of the invention, in the wireless communication apparatus in the twelfth aspect of the invention, the codeword-stream arrangement determination section has a table indicating an arrangement relationship between the codewords and the streams in each retransmission situation together with the communicating station and determines the arrangement of the codewords and the streams based on the table.

Accordingly, the table indicating the arrangement relationship between the codewords and the streams is used and appropriate arrangement of codewords and streams can be set in each retransmission situation of the presence or absence of retransmission, etc.

According to a sixteenth aspect of the invention, in the wireless communication apparatus in the twelfth aspect of the invention, the codeword-stream arrangement determination section acquires codeword-stream arrangement information contained in the control information from the communicating station and determines the arrangement of the codewords and the streams based on the codeword-stream arrangement information.

Accordingly, appropriate arrangement of the codewords and the streams can be set in each retransmission situation of the presence or absence of retransmission, etc., according to the codeword-stream arrangement information from the communicating station.

According to a seventeenth aspect of the invention, in the wireless communication apparatus in the twelfth aspect of the invention, the codeword-stream arrangement determination section determines the number of streams of retransmission codeword in response to an error factor of codeword where the retransmission occurs.

Accordingly, the number of data pieces required for retransmission codeword can be controlled in response to the error factor, so that it is made possible to further suppress lowering of the frequency use efficiency.

According to an eighteenth aspect of the invention, the wireless communication apparatus in the seventeenth aspect of the invention includes a reception quality determination section that determines a reception quality of the codeword received by the reception processing section. The feedback information transmission section transmits feedback information having the reception quality. The codeword-stream arrangement determination section acquires codeword-stream arrangement information contained in the control information from the communicating station and determines the arrangement of the codewords and the streams by the number of streams of retransmission codeword determined in response to the error factor based on the reception quality.

According to a nineteenth aspect of the invention, in the wireless communication apparatus in the twelfth aspect of the invention, the codeword-stream arrangement determination section determines an arrangement of a transmission stream of each codeword and a blanking stream for performing blanking with transmission OFF in response to a rank of ordering based on reception quality of the plurality of streams.

Accordingly, the stream ordering is used, whereby fitted streams in response to the reception situation can be arranged in the blanking stream and the transmission stream, so that the preventing effect of lowering of the frequency use efficiency can be further improved.

According to a twentieth aspect of the invention, the wireless communication apparatus in the nineteenth aspect of the invention includes a stream ordering section that orders the plurality of streams based on reception quality of the codeword received by the reception processing section. The feedback information transmission section transmits the feedback information containing the stream ordering information. The codeword-stream arrangement determination section acquires codeword-stream arrangement information contained in the control information from the communicating station and determines the arrangement of the codewords and the streams by the transmission stream of each codeword determined in response to the rank of the ordering and the blanking stream.

According to a twenty-first aspect of the invention, in the wireless communication apparatus in the twelfth aspect of the invention, the codeword-stream arrangement determination section determines the arrangement of a transmission stream of each codeword and a blanking stream for performing blanking with transmission OFF in response to an error factor of the codeword where the retransmission occurs and a rank of ordering based on reception quality of the plurality of streams.

Accordingly, the number of data pieces required for retransmission codeword can be controlled and fitted streams in response to the reception situation can be arranged in the blanking stream and the transmission stream, so that it is made possible to further suppress lowering of the frequency use efficiency.

According to a twenty-second aspect of the invention, the wireless communication apparatus in the twenty-first aspect of the invention includes a reception quality determination section that determines a reception quality of the codeword received by the reception processing section; and a stream ordering section that orders the plurality of streams based on the reception quality. The feedback information transmission section transmits the feedback information having the reception quality and the stream ordering information. The codeword-stream arrangement determination section acquires codeword-stream arrangement information contained in the control information from the communicating station and determines the arrangement of the codewords and the streams by the number of streams of retransmission codeword determined in response to the error factor based on the reception quality and a transmission stream of each codeword determined in response to the rank of the ordering and a blanking stream.

According to a twenty-third aspect of the invention, there is provided a wireless communication base station apparatus including the wireless communication apparatus in any one of the first to twenty-second aspects according to the invention.

According to a twenty-fourth aspect of the invention, there is provided a wireless communication mobile station apparatus including the wireless communication apparatus in any one of the first to twenty-second aspects according to the invention.

According to a twenty-fifth aspect of the invention, there is provided a wireless communication system for using a plurality of streams per codeword and performing data transmission according to a plurality of codewords, the wireless communication system comprising: a transmission apparatus including: a feedback information reception section that receives feedback information from a reception apparatus of a communicating station; an Ack/Nack detection section that detects Ack/Nack information corresponding to a reception result of the plurality of codewords contained in the feedback information; a codeword-stream arrangement determination section of the transmitting party that determines an arrangement of the codewords and the streams so as to decrease the number of streams while keeping the number of codewords in response to the presence or absence of Nack of the Ack/Nack information when retransmission occurs; and a transmission processing section that performs a transmission processing in response to the arrangement of the codewords and the streams, and a reception apparatus including: a control information acquisition section that acquiring control information from the transmission apparatus of the communicating station; a codeword-stream arrangement determination section of the receiving party that determines the arrangement of the codewords and the streams as with the transmission apparatus based on the control information; a reception processing section that performs a reception processing in response to the arrangement of the codewords and the streams; and a feedback information transmission section that transmits feedback information having a response signal corresponding to a reception result of the plurality of codewords.

According to a twenty-sixth aspect of the invention, there is provided a wireless communication method including performing data transmission according to a plurality of codewords by using a plurality of streams per codeword; and determining an arrangement of codewords and streams so as to decrease the number of streams while keeping the number of codewords when retransmission occurs in the codeword.

### ADVANTAGES OF THE INVENTION

According to the wireless communication apparatus, the wireless communication system, and the wireless communication method according to the invention, lowering of the frequency use efficiency and throughput can be prevented while the blanking advantage is provided at the retransmission time in MCW using a plurality of streams per codeword.

### BRIEF DESCRIPTION OF THE DRAWINGS

FIG. 1 is a drawing to show a state of data transmission at the first transmission time (no blanking).

FIG. 2 is a drawing to show a first example of data transmission at the one-stream blanking transmission time in retransmission (blanking of new CW).

FIG. 3 is a drawing to show a first example of a CW-stream arrangement table according to a first embodiment (when the number of streams for transmitting a new codeword is decreased).

FIG. 4 is a drawing to show a second example of data transmission at the one-stream blanking transmission time in retransmission (blanking of retransmission CW).

FIG. 5 is a drawing to show a second example of the CW-stream arrangement table according to the first embodiment (when the number of streams for transmitting a retransmission codeword is decreased).

FIG. 6 is a drawing to show a CW-stream arrangement table of a modified example wherein the number of transmission antennas is increased.

FIG. 7 is a block diagram to show the configuration of a transmission apparatus of the first embodiment.

FIG. 8 is a block diagram to show the configuration of a reception apparatus of the first embodiment.

FIG. 9 is a chart to show a processing flow of the transmission apparatus of the first embodiment.

FIG. 10 is a chart to show a processing flow of the reception apparatus of the first embodiment.

FIG. 11 is a drawing to show an example of a number-of-streams determination table of retransmission codeword.

FIG. 12 is a drawing to show a specific example of the number-of-streams determination table used in the case where the preceding CQI value is 15.

FIG. 13 is a drawing to show an example of a CW-stream arrangement table according to a second embodiment (when the number of streams of retransmission codeword is set in response to the error factor).

FIG. 14 is a drawing to show a CW-stream arrangement determination table corresponding to FIG. 13.

FIG. 15 is a block diagram to show the configuration of a reception apparatus of the second embodiment.

FIG. 16 is a block diagram to show the configuration of a transmission apparatus of the second embodiment.

FIG. 17 is a chart to show a processing flow of the reception apparatus of the second embodiment.

FIG. 18 is a chart to show a processing flow of the transmission apparatus of the second embodiment.

FIG. 19 is a drawing to show an example of a stream ordering information table.

FIG. 20 is a drawing to show a first example of a CW-stream arrangement table according to a third embodiment (high-rank two streams, low-rank one stream).

FIG. 21 is a drawing to show a second example of the CW-stream arrangement table according to the third embodiment (high-rank one stream, low-rank two streams).

FIG. 22 is a drawing to show a third example of the CW-stream arrangement table according to the third embodiment (to adaptively control the number of streams of retransmission codeword).

FIG. 23 is a block diagram to show the configuration of a reception apparatus of the third embodiment.

FIG. 24 is a block diagram to show the configuration of a transmission apparatus of the third embodiment.

FIG. 25 is a chart to show a processing flow of the reception apparatus of the third embodiment.

FIG. 26 is a chart to show a processing flow of the transmission apparatus of the third embodiment.

FIG. 27 is a drawing to describe blanking processing for each codeword in MCW.

### DESCRIPTION OF REFERENCE NUMERALS

101 Base station
102 User terminal
700, 1600, 2400 Transmission apparatus
701 Feedback information reception section
702 Ack/Nack detection section
703, 1602, 2402 CW-stream arrangement determination section
704 Transmission CW control section
705 Transmission CW generation section
706 CW-stream arrangement section
707, 1603, 2403 Control information generation section
708 MIMO transmission section
709a, 709b, 709c, 709d Antenna
1601 Number-of-retransmission-CW-streams determination section
2401 Ordering information acquisition section
800, 1500, 2300 Reception apparatus
801 Control information acquisition section
802 CW-stream arrangement determination section
803 Stream separation section
804 Stream joining section
805, 806 Decoding section
807, 808 CRC determination section
809, 1504, 2302 Feedback information transmission section
810a, 810b, 810c, 810d Antenna
1501 CW-stream arrangement information acquisition section
1502 Channel estimation section
1503 Reception situation measurement section
2301 Stream ordering section

### BEST MODE FOR CARRYING OUT THE INVENTION

As examples of a wireless communication apparatus, a wireless communication system, and a wireless communication method according to the invention, each embodiment shows a configuration example wherein in a wireless communication system adopting MIMO, a transmission apparatus and a reception apparatus perform signal transmission according to a plurality of codewords (CWs) in a plurality of streams using a plurality of antennas and perform retransmission control (adaptive retransmission control) using HARQ in MCW. The codeword means a data sequence of a control unit of MCS. Here, the case where a signal (stream) is transmitted from a base station to a user terminal and Ack/Nack indicating acknowledgement or no acknowledgement of reception and CQI as reception quality are fed back from the user terminal to the base station in a cellular system is assumed. In this case, the base station (wireless communication base station apparatus) becomes the transmission apparatus (transmission station) and the user terminal (wireless communication mobile station apparatus) becomes the reception apparatus (reception station). In the embodiments, in MCW, data transmission is performed using a plurality of streams per codeword. The following embodiments are examples for description and the invention is not limited to the embodiments.

### First Embodiment

First, as a first embodiment, a configuration example of a wireless communication apparatus for performing processing of performing stream blanking (transmission OFF) in a plurality of streams per codeword and decreasing the number of transmission streams without decreasing the number of transmission codewords at the retransmission occurrence time will be discussed.

To begin with, the stream blanking, a point of the invention, will be discussed. If stream blanking is performed in a plurality of streams per codeword of a plurality of codewords, the blanking advantages can be provided without decreasing the number of codewords to be multiplexed. The blanking advantages are (1) increase in signal strength by transmission power distribution and (2) improvement of reception diversity gain. The advantages will be discussed briefly.

(1) Increase in Signal Strength by Transmission Power Distribution

The maximum value of transmission power of a signal transmitted from a base station is defined. This is a value defined according to a law or specifications. To transmit from a plurality of antennas, generally the value is defined as the maximum value of total power of transmission power of the signal transmitted from each antenna. Thus, to decrease the number of transmission streams by stream blanking, transmission power is distributed to the transmission streams so that the total transmission power becomes constant. For example, if it is determined that the number of transmission antennas is four and the maximum total transmission power is 1 and quarter power is distributed to the stream transmitted from each antenna, when one stream is blanked and three streams are transmitted, one-third power is distributed to the stream transmitted from each antenna because the total transmission power is constant. Thus, the signal strength of the transmission stream increases by stream blanking.

(2) Improvement of Reception Diversity Gain

A general method of a reception method of SDM is spatial filtering by MMSE (Minimum Mean Squared Error) and ZF (Zero Focusing). In the reception method by the spatial filtering, reception diversity gain of (number of reception antennas−number of transmission antennas+1) is obtained. For example, if the number of transmission antennas is 4 and the number of reception antennas is 4, the reception diversity gain is 1; if the number of transmission antennas is 2 and the number of reception antennas is 4, the reception diversity gain is 3. Although the number of reception antennas installed in the reception terminal cannot be increased, the number of transmission streams can be decreased and the number of transmission antennas can be decreased. Therefore, the reception diversity gain can be improved by stream blanking for decreasing the number of transmission streams.

From the viewpoint described above, in the first embodiment, if Nack occurs and retransmission occurs, a stream in a plurality of streams assigned per codeword is blanked without decreasing the number of codewords to be multiplexed. Thus, the number of transmission streams is decreased without decreasing the number of transmission codewords at the retransmission occurrence time, whereby while the blanking advantage at the retransmission time is obtained, the number of multiplexed codewords is ensured and new data is transmitted, so that lowering of the frequency use efficiency can be prevented.

Next, a specific method of stream blanking in the first embodiment is illustrated. Here, a system wherein the number of transmission antennas is 4, the number of reception antennas is 4, the number of transmission codewords is 2, and each codeword is transmitted in two streams is assumed and an example wherein two codewords are transmitted in four streams at the first transmission time at which no retransmission occurs is shown. In this case, two streams for each of two codewords CW1 and CW2, four streams in total are transmitted from the base station (BS) of the transmission apparatus to the user terminal (UE) of the reception apparatus and Ack/Nack of each stream is fed back from the user terminal to the base station.

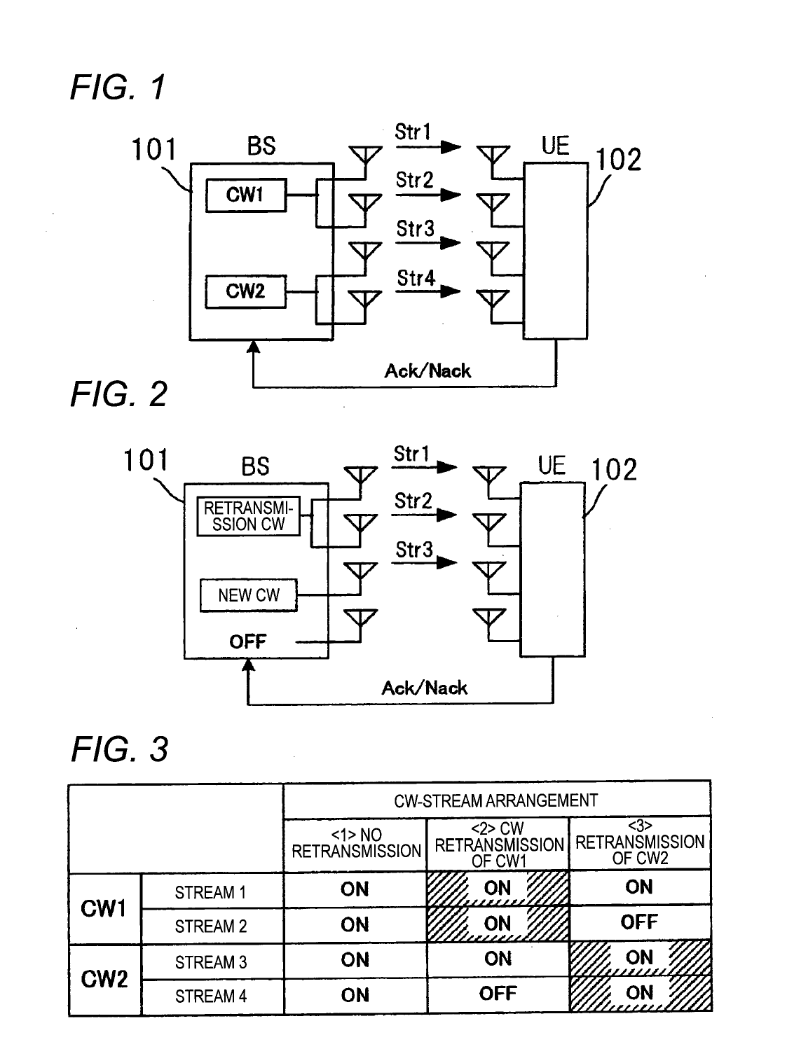

First, the first transmission time at which no retransmission occurs will be discussed. FIG. 1 is a drawing to show a state of data transmission at the first transmission time (no blanking). In a base station 101, an error determination code of CRC code, etc., is added to transmission data, error correction coding of Turbo code, etc., is performed, and codeword is generated. At the first transmission time at which no retransmission occurs, to a user terminal 102, the base station 101 divides code word 1 (CW1) into two parts and transmits from stream 1 (Str1) and stream 2 (Str2) and likewise transmits code word 2 (CW2) from stream 3 (Str3) and stream 4 (Str4). “<1> no retransmission CW” in a CW-stream arrangement table in FIG. 3 to show the arrangement relationship between codewords and streams in each retransmission situation of presence/absence of retransmission, etc., described later corresponds to the situation.

In the user terminal 102, stream separation is performed for a reception signal. Next, the data subjected to the stream separation is joined and CW1 and CW2 are generated. The joined codewords are decoded and error determination is made. If an error is detected, the user terminal 102 feeds back Nack to the base station 101; if no error is detected, the user terminal 102 feeds back Ack to the base station 101.

Next, the case where an error occurs in transmitted codeword and retransmission occurs will be discussed. FIG. 2 is a drawing to show a first example of data transmission at the one-stream blanking transmission time in retransmission (blanking of new CW). If retransmission occurs, the base station 1 does not decrease the number of codewords and decreases the number of streams and transmits to the user terminal 102. For example, if retransmission occurs in one codeword, the number of streams for transmitting a retransmission codeword (retransmission CW) is not decreased and the number of streams for transmitting a new codeword (new CW) is decreased.

FIG. 3 is a drawing to show a first example of a CW-stream arrangement table to show the arrangement relationship between codewords and streams (when the number of streams for transmitting a new codeword is decreased). In the example in FIG. 3, to transmit CW1 using stream 1 and stream 2 and CW2 using stream 3 and stream 4, corresponding to the retransmission situation, all streams are used for transmission in <1> no retransmission CW, stream 4 is set to transmission OFF in <2> retransmission of CW1, and stream 2 is set to transmission OFF in <3> retransmission of CW2. The hatched portion in FIG. 3 indicates retransmission codeword.

The base station 101 knows occurrence of an error in one codeword according to Ack/Nack information fed back from the user terminal 102, and retransmits the codeword. For example, if an error occurs in CW1 and retransmission is performed, <2> in the CW-stream arrangement table of FIG. 3 is selected. CW1 of retransmission codeword is transmitted using the same stream 1 and stream 2 as at the first transmission time. Accordingly, as many data pieces as the number of data pieces at the first transmission time can be retransmitted. The retransmission data may be the same data as at the first transmission time or may be untransmitted redundant data after coding. Thus, a sufficient gain by retransmission is obtained, so that the advantage of retransmission is large. CW2 of a new codeword is transmitted using stream 3 by decreasing the number of streams. Accordingly, new data can be transmitted for conventional blanking processing for each codeword. The number of transmission streams is decreased and blanking transmission is performed, so that the advantage of blanking described above can be provided.

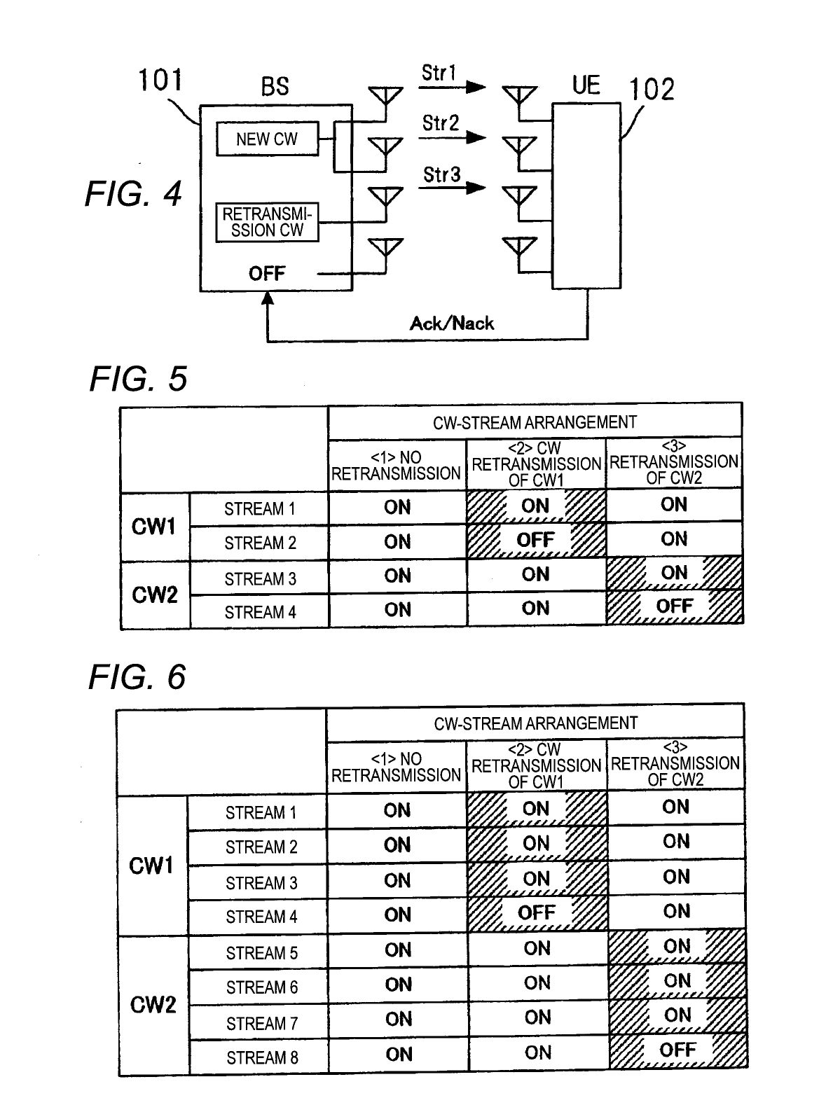

Another example wherein retransmission occurs will be discussed. FIG. 4 is a drawing to show a second example of data transmission at the one-stream blanking transmission time in retransmission (blanking of retransmission CW). As in the second example, unlike the first example shown in FIGS. 2 and 3, if retransmission occurs, the number of streams for transmitting a retransmission codeword can also be decreased without decreasing the number of streams for transmitting a new codeword.

FIG. 5 is a drawing to show a second example of the CW-stream arrangement table to show the arrangement relationship between codewords and streams (when the number of streams for transmitting a retransmission codeword is decreased). In the example in FIG. 5, to transmit CW1 using stream 1 and stream 2 and CW2 using stream 3 and stream 4, corresponding to the retransmission situation, all streams are used for transmission in <1> no retransmission CW, stream 2 is set to transmission OFF in <2> retransmission of CW1, and stream 4 is set to transmission OFF in <3> retransmission of CW2. The hatched portion in FIG. 5 indicates retransmission codeword as in FIG. 3.

In a codeword where an error occurred, error correction may be able to be made simply by increasing a redundant bit. For example, for a codeword set at target PER and erroneous at random, PER is largely improved simply by setting to MCS one lower. This is equivalent to lowering one step of MCS. An error can be corrected by increasing a redundant bit. Thus, only a redundant bit is transmitted in retransmission codeword, whereby the error can be corrected without retransmitting more than necessary data. In this case, the number of data pieces to be retransmitted may be less than the number of data pieces at the first transmission time and thus if the number of streams for transmitting the retransmission codeword is decreased, the advantage of retransmission can be provided.

The base station 101 knows that an error occurs in one codeword according to Ack/Nack information fed back from the user terminal 102, and retransmits the codeword. For example, if an error occurs in CW2 and the codeword is retransmitted, <3> in the CW-stream arrangement table in FIG. 5 is selected. CW1, new codeword, is transmitted using the same stream 1 and stream 2 as at the first transmission time. Accordingly, a large number of data pieces that can be newly transmitted can be ensured. CW2, retransmission codeword, is transmitted using stream 3 with the number of streams decreased. Accordingly, the advantage of retransmission can be provided as described above. The number of transmission streams is decreased and blanking transmission is performed, whereby the blanking advantage described above can be provided as in the first example.

An error may occur in all transmitted codewords and retransmission may occur. In this case, stream blanking is not performed and retransmission codeword is transmitted using as many streams as the number of streams at the first transmission time. That is, if an error occurs in all codewords, <1> in FIG. 3 or FIG. 5 is used and retransmission is performed as at the first transmission time.

Both transmission apparatus and reception apparatus previously possess the CW-stream arrangement table in FIG. 3 and FIG. 5, whereby the number of transmission streams and the CW-stream arrangement can be shared between the transmission apparatus and reception apparatus by sending only information of new codeword or retransmission codeword of each codeword. The number of transmission streams and the CW-stream arrangement may be used as control information separately.

Selection as to which of the CW-stream arrangement tables in FIG. 3 and FIG. 5 may be determined at the communication start time or may be changed in a comparatively long period for a wireless frame of a communication line. At the time, notification as to which table is selected is provided so that the same CW-stream arrangement table can be used in both transmission and reception. At this time, the transmitting apparatus may determine the table and may notify the receiving apparatus of the determined table or vice versa. If there is a room for the control line for providing notification for each wireless frame, the table may be changed in the period of the wireless frame.

In the embodiment, the number of transmission antennas is four, the number of reception antennas is four, the number of transmission codewords is two, and each codeword is transmitted in two streams by way of example, but the invention is not limited to it; the embodiment can also be applied likewise in other conditions. FIG. 6 is a drawing to show a CW-stream arrangement table of a modified example wherein the number of transmission antennas is increased. FIG. 6 shows an example of a CW-stream arrangement table wherein the number of transmission antennas is increased to eight from four, the number of transmission codewords is two, and each codeword is transmitted in four streams. Like FIG. 5, FIG. 6 shows an example to show the case where retransmission codeword is blanked. It can also be applied to the case where new codeword is blanked as in FIG. 3.

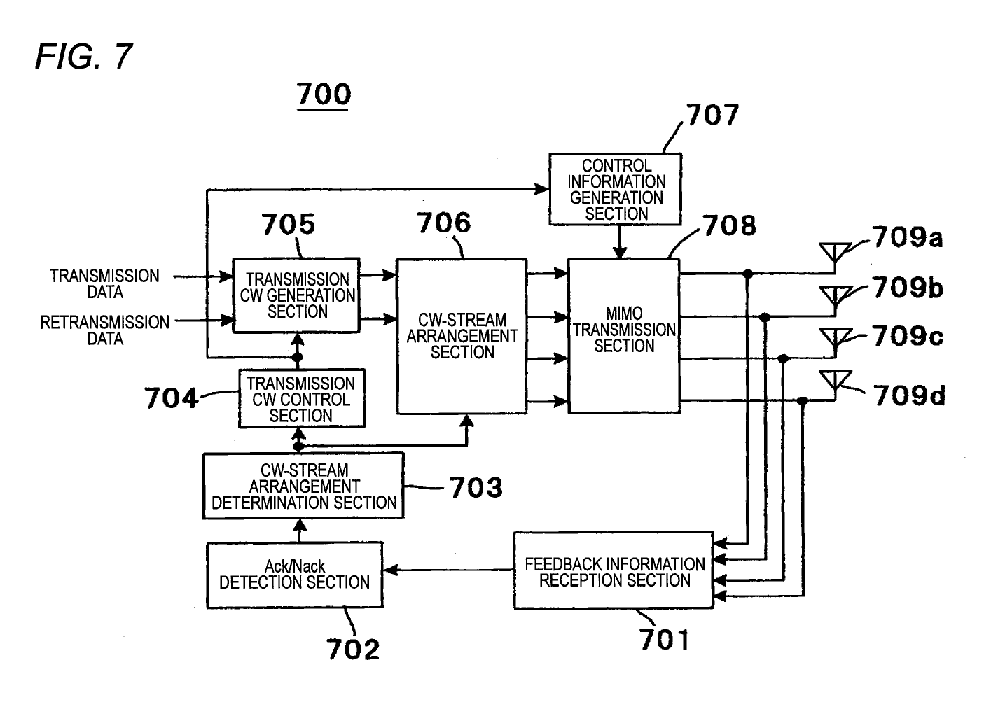

Next, a specific configuration example of the wireless communication apparatus according to the first embodiment is shown. FIG. 7 is a block diagram to show the configuration of the transmission apparatus of the first embodiment. A transmission apparatus 700 is made up of a feedback reception information section 701, an Ack/Nack detection section 702, a CW-stream arrangement determination section 703, a transmission CW control section 704, a transmission CW generation section 705, a CW-stream arrangement section 706, a control information generation section 707, an MIMO transmission section 708, and a plurality of antennas 709a, 709b, 709c, and 709d. The example in FIG. 7 is the configuration of four streams, two-codeword transmission.

The feedback reception information section 701 performs reception processing for feedback information from the reception apparatus of the communicating station. The Ack/Nack detection section 702 detects Ack/Nack information indicating acknowledgement or no acknowledgement of reception of each codeword contained in the feedback information from the reception apparatus. The CW-stream arrangement determination section 703 holds the CW-stream arrangement tables as in FIG. 3 and FIG. 5 and determines CW-stream arrangement concerning assignment of codeword and stream based on the Ack/Nack detection result in the Ack/Nack detection section 702.

The transmission CW control section 704 sets the data length of transmission codeword based on the CW-stream arrangement determined by the CW-stream arrangement determination section 703. When the transmission codeword is transmitted in two streams, the data length is set to that for two streams; when the transmission codeword is transmitted in one stream, the data length is set to that for one stream.

The transmission CW generation section 705 generates each transmission codeword so that the data length becomes the data length set by the transmission CW control section 704. At this time, a new codeword is generated by adding an error determination code of CRC, etc., to new transmission data and performing error correction coding of Turbo code, etc. Coded data is saved for the case where an error will occur in the transmission codeword and retransmission will occur. On the other hand, retransmission codeword is generated by extracting retransmission data from the saved post-coded data. The generation method of retransmission data includes a method of using the same data as transmitted at the first transmission time, a method of using a post-coded redundant bit not transmitted at the first transmission time.

The CW-stream arrangement section 706 places codeword in each stream in accordance with the CW-stream arrangement determined by the CW-stream arrangement determination section 703 about the codeword generated in the transmission CW generation section 705. The control information generation section 707 generates control information concerning transmission codeword. The control information of the transmission codeword includes MCS information, retransmission control information, etc., of the transmission codeword, for example.

The MIMO transmission section 708 performs MIMO transmission (SDM transmission) of a plurality of generated transmission codewords in a plurality of streams (here, two streams) through the antennas 709a, 709b, 709c, and 709d to the reception apparatus of the communicating station. The MIMO transmission section 708 is not limited if it can perform SDM transmission of a plurality of streams. For example, a method of transmitting each stream from separate antennas, a method of multiplying each stream by a transmission weight and transmitting from each antenna, and the like exist. The MIMO transmission section 708 transmits the control information generated by the control information generation section 707. The control information need not necessarily be a configuration for performing SDM transmission.

In the configuration described above, the transmission CW generation section 705, the CW-stream arrangement section 706, and the MIMO transmission section 708 implement the function of a transmission processing section.

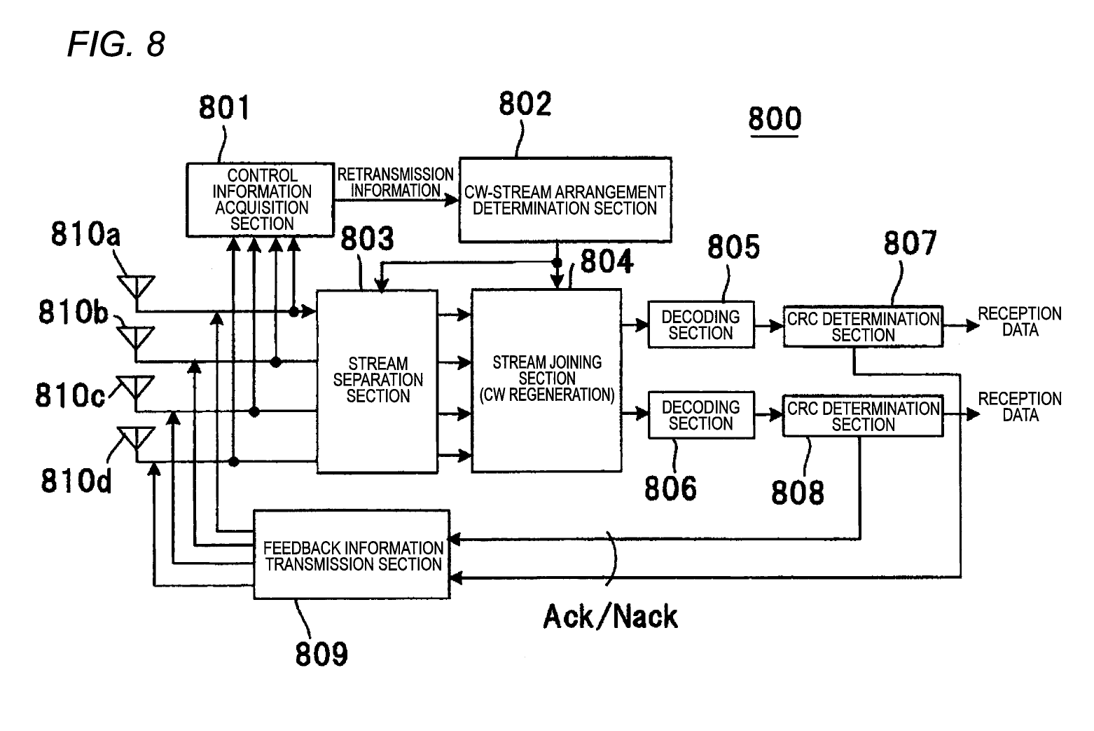

FIG. 8 is a block diagram to show the configuration of the reception apparatus of the first embodiment. A reception apparatus 800 is made up of a control information acquisition section 801, a CW-stream arrangement determination section 802, a stream separation section 803, a stream joining section 804, decoding sections 805 and 806, CRC determination sections 807 and 808, a feedback information transmission section 809, and a plurality of antennas 810a, 810b, 810c, and 810d.

The control information acquisition section 801 acquires control information transmitted from the transmission apparatus of the communicating station from a reception signal. The control information includes MCS (modulation and coding rate) information and retransmission control information of each codeword. Although not shown in FIG. 8, generally the MCS information and the retransmission control information of each codeword are used in the stream separation section 803, the decoding sections 805 and 806, etc.

If retransmission codeword is contained in the codeword transmitted in the control information acquisition section 801, the CW-stream arrangement determination section 802 acquires the same information as the information of the CW-stream arrangement determined in the CW-stream arrangement determination section 703 in the transmission apparatus in FIG. 7. Specifically, like the CW-stream arrangement determination section 703 in the transmission apparatus in FIG. 7, the CW-stream arrangement determination section 802 holds CW-stream arrangement tables as in FIG. 3 and FIG. 5 and determines CW-stream arrangement based on information as to whether the transmission codeword is a new codeword or a retransmission codeword, contained in the acquisition result of the control information acquisition section 801. Thus, the CW-stream arrangement table is shared between both transmission and reception, whereby CW-stream arrangement information can be shared between the transmission apparatus and the reception apparatus according to retransmission occurrence information only.

The stream separation section 803 separates reception signal of a plurality of streams transmitted from the transmission apparatus 700 of the communicating station and received at the antennas 810a, 810b, 810c, and 810d. The stream separation section 803 is not limited if it can separate signal transmitted in SDM. For example, a stream separation method of filtering such as Zero Forcing or MMSE, a stream separation method of SIC (Successive Interference Cancellation), and the like exist. At this time, the stream separation section 803 performs stream separation processing using the CW-stream arrangement information determined by the CW-stream arrangement determination section 802. Accordingly, if the number of transmission streams is small, the blanking advantage can be provided in the stream separation processing.

The stream joining section 804 joins the streams separated by the stream separation section 803 using the CW-stream arrangement information determined by the CW-stream arrangement determination section 802 and regenerate transmission codeword. The decoding sections 805 and 806 perform decoding processing for the codeword regenerated by the stream joining section 804. The CRC determination sections 807 and 808 perform CRC check for the codewords subjected to the decoding processing by the decoding sections 805 and 806 and determine whether or not an error occurs in the codeword. If the CRC determination sections 807 and 808 determine that no error occurs, data is output as reception data of each codeword. The determination results of the CRC determination sections 807 and 808 are output as Ack/Nack information.

The feedback information transmission section 809 performs transmission information to feed back the Ack/Nack information from the CRC determination sections 807 and 808 and any other feedback information to the transmission apparatus 700 of the communicating station.

In the configuration described above, the stream separation section 803, the stream joining section 804, and the decoding sections 805 and 806 implement the function of a reception processing section.

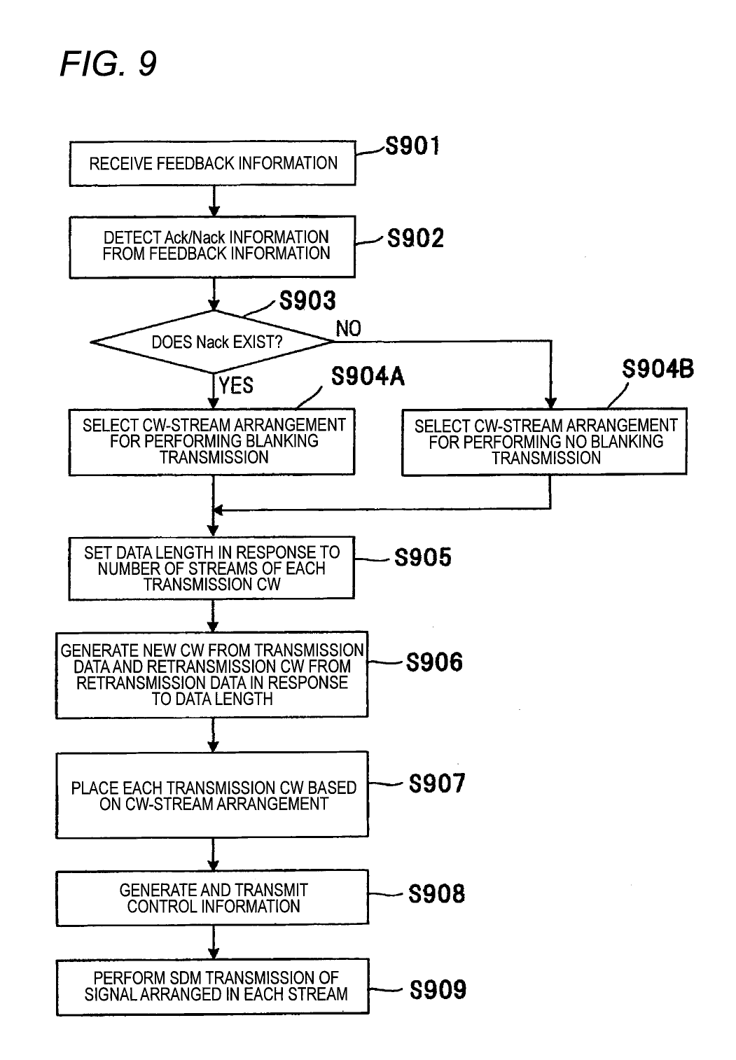

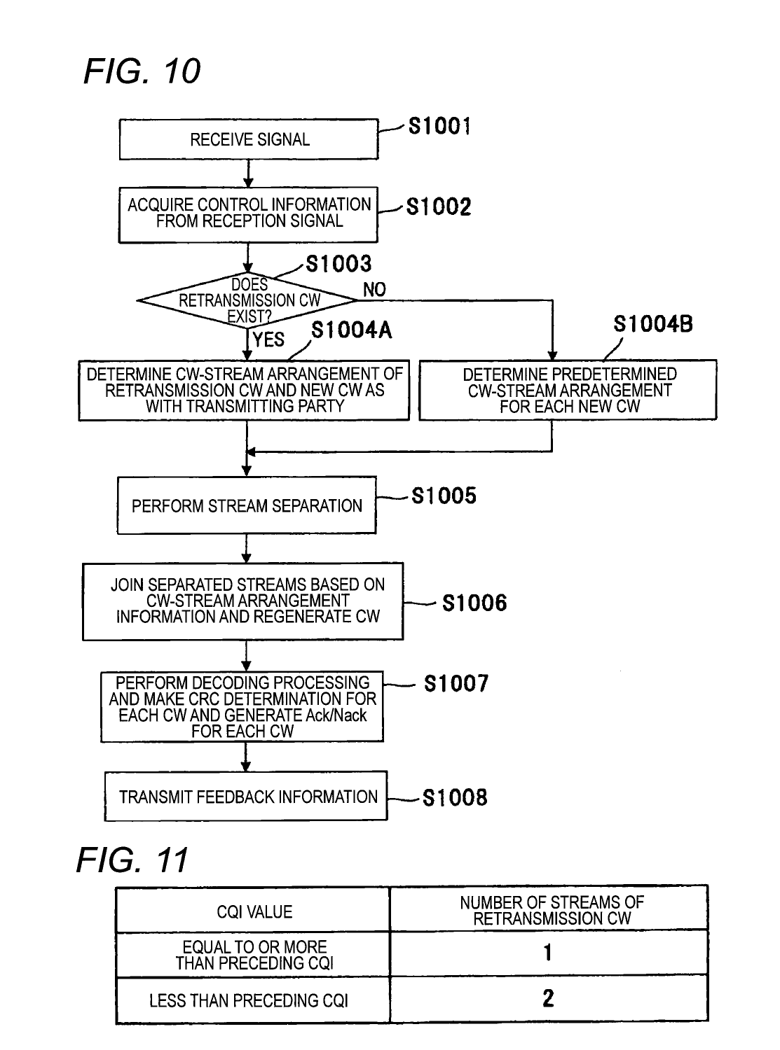

Next, a processing flow in the wireless communication apparatus of the first embodiment will be discussed. FIG. 9 is a chart to show a processing flow of the transmission apparatus of the first embodiment, and FIG. 10 is a chart to show a processing flow of the reception apparatus of the first embodiment. Here, the characteristic processing of the embodiment will be discussed and general processing for conducting MCW communications is omitted. In the examples in the processing flow, the number of transmission streams is four and the number of transmission codewords is two.

To begin with, the processing flow of the transmission apparatus 700 will be discussed in order with FIG. 9.

(Step S901) The feedback reception information section 701 receives feedback information from the reception apparatus 800.

(Step S902) The Ack/Nack detection section 702 detects Ack/Nack information from the feedback information received at step S901.

(Step S903) The Ack/Nack detection section 702 determines whether or not Nack exists, namely, retransmission occurs. If Nack exists, the process goes to step S904A; if Nack does not exist, the process goes to step S904B.

(Step S904A) If Nack exists, the CW-stream arrangement determination section 703 selects CW-stream arrangement for performing blanking transmission. For example, to use the CW-stream arrangement table in FIG. 3 or FIG. 5, transmission method <2> or <3> is selected.

(Step S904B) If Nack does not exist, the CW-stream arrangement determination section 703 selects CW-stream arrangement for performing no blanking transmission. For example, to use the CW-stream arrangement table in FIG. 3 or FIG. 5, transmission method <1> is selected.

(Step S905) The transmission CW control section 704 sets the data length of each transmission codeword in response to the number of streams of each transmission codeword based on the CW-stream arrangement selected at step S904A or S904B.

(Step S906) The transmission CW generation section 705 generates each transmission codeword in response to the data length set at step S905. Here, retransmission codeword is generated from retransmission data and new codeword is generated from transmission data.

(Step S907) The CW-stream arrangement section 706 places each transmission codeword generated at step S906 in streams based on the CW-stream arrangement selected at step S904A or S904B.

(Step S908) The control information generation section 707 generates and transmits control information of each codeword. The control information includes retransmission control information, MCS, etc.

(Step S909) The MIMO transmission section 708 performs MIMO transmission (SDM transmission) of transmission signal from each stream arranged at step S907 through the antennas 709a, 709b, 709c, and 709d.

The processing flow of the reception apparatus 800 will be discussed in order with FIG. 10.

(Step S1001) A signal transmitted from the transmission apparatus 700 is received through the antennas 810a, 810b, 810c, and 810d.

(Step S1002) The control information acquisition section 801 acquires control information from the reception signal received at step S1001.

(Step S1003) The control information acquisition section 801 determines retransmission codeword exists based on the acquired control information. If retransmission codeword exists, the process goes to step S1004A; if retransmission codeword does not exist, the process goes to step S1004B.

(Step S1004A) If retransmission codeword exists, the CW-stream arrangement determination section 802 sets transmission streams of new codeword and retransmission codeword as CW-stream arrangement as at step S904A in the processing flow of the transmission apparatus in FIG. 9. For example, as with the transmission apparatus 700, to use the CW-stream arrangement table in FIG. 3 or FIG. 5, transmission method <2> or <3> is selected.

(Step S1004B) If retransmission codeword does not exist, the CW-stream arrangement determination section 802 sets transmission streams of new codeword as CW-stream arrangement as at step S904B in the processing flow of the transmission apparatus in FIG. 9. For example, as with the transmission apparatus 700, to use the CW-stream arrangement table in FIG. 3 or FIG. 5, transmission method <1> is selected.

(Step S1005) The stream separation section 803 performs stream separation of the reception signal in response to the number of streams of transmission streams according to the CW-stream arrangement determined at step S1004A or S1004B.

(Step S1006) The stream joining section 804 joins the streams separated at step S1005 in response to the CW-stream arrangement determined at step S1004A or S1004B and regenerates transmission codeword.

(Step S1007) The decoding sections 805 and 806 perform decoding processing for each codeword regenerated at step S1006, the CRC determination sections 807 and 808 make error determination, and Ack/Nack information is generated for each codeword based on the error determination result.

(Step S1008) The feedback information transmission section 809 performs transmission processing so as to feed back the Ack/Nack information generated at step S1007 and any other feedback information to the transmission apparatus 700.

Thus, in the first embodiment, stream blanking is performed in a plurality of streams per codeword and when retransmission occurs, the operation of decreasing the number transmission streams is performed without decreasing the number of transmission codewords. Accordingly, if blanking frequently occurs, while the blanking advantage is provided for retransmission codeword, the number of multiple codewords is ensured and new data can be transmitted, so that lowering of the frequency use efficiency can be prevented.

As a modified example of the first embodiment, the following configuration can also be named as a variation of processing when Nack occurs at the same time in a plurality of codewords:

In this modified example, since Nack occurs in a plurality of codewords, one stream is blanked in each codeword as in the first embodiment and a plurality of codewords are transmitted. At this time, in each codeword, the coding rate at the first transmission time varies and thus the number of remaining redundant bits varies. As the retransmission data, if redundant bit is transmitted and coding gain is obtained, the retransmission advantage can be provided larger than that if a systematic bit is transmitted and is combined with a first transmission bit to obtain a gain. Then, for each retransmission codeword, the number of transmission streams is determined in response the remaining number of redundant bits. For example, a codeword with the large remaining number of redundant bits is transmitted in two streams and a codeword with the small remaining number of redundant bits is transmitted in one stream. Accordingly, if retransmission occurs at the same time in a plurality of codewords, retransmission for providing the blanking advantage can be performed, so that retransmission is resolved early and lowering of the frequency efficiency can be prevented.

### Second Embodiment

Next, as a second embodiment, a configuration example of a wireless communication apparatus for performing processing of determining the factor of an error at the blanking transmission time when retransmission occurs and controlling the number of data pieces to be retransmitted will be discussed.

In MCW, if the number of streams per codeword varies, the number of data pieces that can be transmitted in each codeword varies and thus efficient transmission is made possible by transmitting as many data pieces as required. Particularly, in retransmission codeword, the number of retransmission data pieces can be changed and retransmission efficiency can be improved by transmitting as many retransmission data pieces as required. If retransmission data is not so much required in retransmission codeword, frequency efficiency can be improved by increasing the number of data pieces of new codeword.

From the viewpoint described above, in the second embodiment, the error factor (error state) of codeword where an error occurs is determined by the reception state and the number of streams required for retransmission codeword is determined.

Here, the error factor will be discussed in detail. Errors occurring in transmission codeword can be classified into the following two from the factors: First error is an error occurring at random according to the target PER of transmission codeword. Second error is an error occurring because the reported reception situation and the reception situation at the actual data transmission time differ.

MCS of transmission codeword is selected based on the reception situation measured in the receiving party and fed back to the transmitting party. The reception situation includes CQI indicating the reception quality. In MCS selection, it is a general practice to select the maximum MCS satisfying the target PER according to fed-back CQI. As the target PER, generally, about 10-20% is used. Thus, in transmission codeword, an error occurs at random according to the target PER.

On the other hand, if CQI at the time of the actual data transmission varies for the CQI measured in the receiving party and fed back and the reception situation is degraded, there is a possibility that an error may occur in transmission code word. In this case, MCS of transmission codeword is selected based on the fed-back CQI. Thus, if transmission is performed in worse situation than the CQI, the required reception quality cannot be ensured for the selected MCS and thus an error occurs.

As described above, for errors occurring due to different factors, the number of data pieces required at the retransmission time varies. So much retransmission data is not required for an error occurring at random; whereas, much retransmission data becomes required for an error occurring because the reception situation is degraded.

For an error occurring at random, if the selected MCS is lowered even only one and transmission is performed, PER is largely improved, so that an error becomes hard to occur. Then, as a method of providing an equivalent advantage to lowering of MCS, a method of transmitting a redundant bit at the retransmission time exists. In this case, a large number of redundant bits need not be transmitted and thus the number of streams of retransmission codeword may be decreased and the number of retransmission data pieces may be decreased. The number of transmission streams can be assigned to new codeword and new data can be much transmitted, so that lowering of the frequency use efficiency can be prevented.

On the other hand, for an error occurring because the reception situation is degraded, sufficient quality cannot be obtained in MCS based on the fed-back CQI and there is a possibility that an error may occur. In this case, as retransmission data, the number of streams of retransmission codeword is increased, a large number of redundant bits are retransmitted, and a high coding gain is obtained, whereby an error can be eliminated. Thus, retransmission is resolved early, whereby an occasion of transmitting new data can be increased and lowering of the frequency efficiency can be prevented.

Different error factors as described above can be determined as follows using the fed-back CQI: For example, the case where the value of the preceding fed-back CQI is 15 and MCS of transmission codeword is selected based on the value is considered. Transmission codeword is transmitted and Ack/Nack information of the codeword and CQI at the reception time of the codeword are fed back from the receiving party. If the value of CQI is 15 or more and an error occurs (Nack), it is considered that the error is an error occurring at random. On the other hand, if the value of CQI is 14 or less and an error occurs (Nack), it is considered that the error is an error occurring because the reception situation is degraded. Thus, the error factor can be determined according to the fed-back Ack/Nack information and CQI value.

Next, a specific method of stream blanking in the second embodiment is illustrated. Here, as in the first embodiment, a system in which the number of transmission antennas is four, the number of reception antennas is four, the number of transmission codewords is two, and each codeword is transmitted in two streams is assumed and an example wherein two codewords are transmitted in four streams at the first transmission time at which retransmission does not occur is shown.

To begin with, the reception apparatus feeds back CQI and Ack/Nack information of each codeword are fed back to the transmission apparatus as the reception situation of each codeword. Upon reception of Nack, the transmission apparatus determines the error factor using the fed-back CQI as described above for the codeword where an error occurs, and selects the number of streams of retransmission codeword.

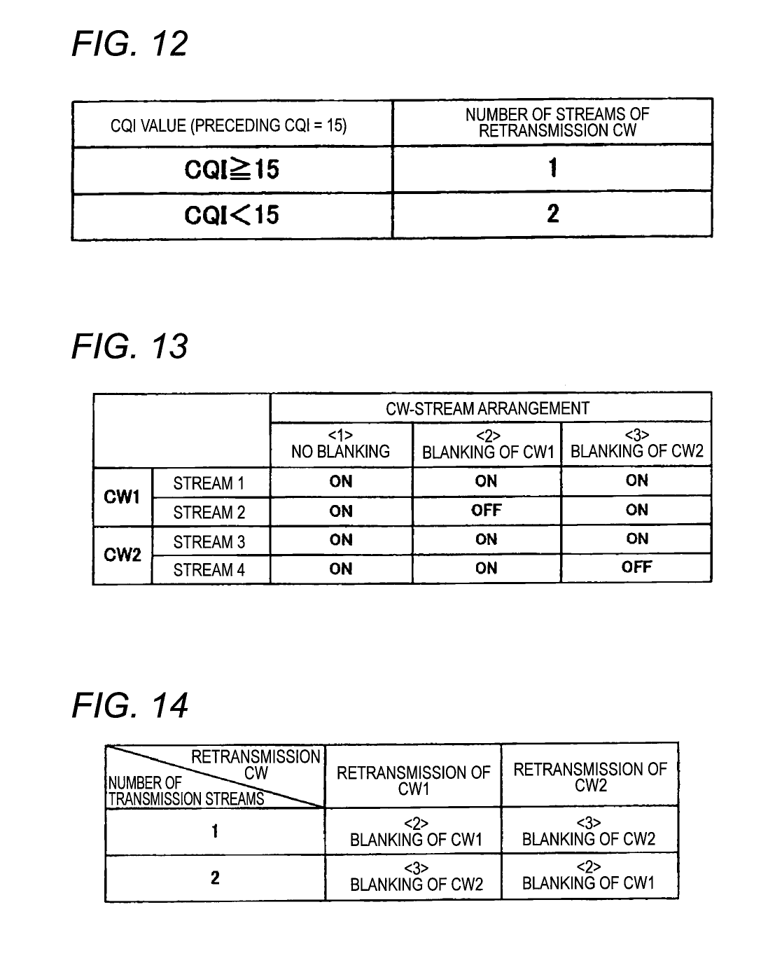

FIG. 11 is a drawing to show an example of a number-of-streams determination table of retransmission codeword. FIG. 12 is a drawing to show a specific example of the number-of-streams determination table used in the case where the preceding CQI value is 15. The number of streams of retransmission codeword can be determined using the number-of-streams determination table as shown in FIG. 11. In this case, if the current CQI value is equal to or more than the preceding CQI, it is assumed that the error is an error occurring at random and the number of streams of retransmission codeword is set to one; if the current CQI value is less than the preceding CQI, it is assumed that the error is an error occurring because the reception situation is degraded and the number of streams of retransmission codeword is set to two. For example, if the preceding CQI value is 15, the number-of-streams determination table as in FIG. 12 is used. In this example, the number of streams of retransmission codeword is determined according to whether the CQI value is equal to or more than or is less than the preceding CQI value 15.

The transmission apparatus selects CW-stream arrangement using a CW-stream arrangement table as in the first embodiment. FIG. 13 is a drawing to show an example of the CW-stream arrangement table to show the arrangement relationship between codewords and streams (when the number of streams of retransmission codeword is set in response to the error factor). FIG. 14 is a drawing to show a CW-stream arrangement determination table corresponding to FIG. 13.

In the transmission apparatus, the CW-stream arrangement table as in FIG. 3 is previously provided and CW-stream arrangement is selected and is determined. At this time, for example, using the CW-stream arrangement determination table as in FIG. 14, the codeword to be blanked is determined by the number of streams of retransmission codeword determined as mentioned above and the retransmission codeword number and the CW-stream arrangement can be selected. For example, if retransmission occurs in CW1 and the number of transmission streams of retransmission codeword is determined one, <2> is selected as the CW-stream arrangement. If retransmission occurs in CW1 and the number of transmission streams of retransmission codeword is determined two, <3> is selected as the CW-stream arrangement.

The transmission apparatus sends CW-stream arrangement information indicating the transmission method in the CW-stream arrangement table to the reception apparatus as control information. Accordingly, the reception apparatus can perform reception processing without mistaking the CW-stream arrangement. In this case, the blanking advantage can also be provided as in the first embodiment described above.

In the second embodiment, the transmission apparatus determines the number of streams of retransmission codeword, but the reception apparatus may determine the number of streams of retransmission codeword. In this case, the number of streams of retransmission codeword determined by the receiving party is fed back to the transmitting party. For the determination method of the number of streams of retransmission codeword, the same method as in the example described above can be used.

In the embodiment, CQI comparison is used as the indicator of the reception situation for determining the error factor, but the invention is not limited to it; for example, the following exists:

(1) Interstream Interference

If streams cannot completely be separated in stream separation in the receiving party, interstream interference remains and thus an error may occur. The interference amount of the interstream interference is measured, whether the error is an error occurring at random or an error caused by interference is determined by the magnitude of the interference amount, and the number of streams of retransmission codeword can be set.

(2) MIMO Reception Processing System

Generally, the MIMO reception processing method itself is not standardized and the MIMO reception processing method may vary from one terminal to another. As compared with a terminal including an MIMO reception processing method by spatial filtering of MMSE, etc., a terminal including an MIMO reception processing method with a high interference suppression effect such as SIC can suppress interstream interference and thus has a good reception characteristic. However, in such interference suppression processing, only if no error occurs in one codeword of multiplexed codeword and a precise replica can be generated, the reception characteristic is good; if a precise replica cannot be generated, the interference suppression effect cannot be expected. Thus, it becomes important to use what MIMO reception processing for data to be retransmitted if an error occurs. Then, notification of MIMO reception processing system is provided and it can be used for determining the number of streams of retransmission codeword.

(3) If an Error that Cannot be Resolved in Coding Gain Occurs

If an error occurs and retransmission is repeated and a coding gain is enhanced, there is a possibility that an error that cannot be corrected will occur. It is considered that the reception situation of a specific data part becomes remarkably bad due to fading variation, etc., and data which becomes important in decoding is transmitted in the portion, etc. For example, in a communication system using OFDM (Orthogonal Frequency Division Multiplexing), the reception situation of a specific frequency component is remarkably bad due to frequency selective fading, etc. In this case, if retransmission is repeated many times and the coding gain is enhanced, error correction cannot be made and thus notification that the error cannot be resolved by retransmission is provided and new data is transmitted, whereby the error can be resolved.

(4) If Reception Situation is Remarkably Bad and Error Correction Cannot Be Expected Even if Retransmission is Performed

If the reception situation is remarkably bad, even if retransmission is performed, the combining effect cannot be expected because the reliability of the preceding reception data is low. In such a case, combining with the preceding reception data is not required. Self-decodable data is transmitted, whereby the error can be resolved.

(5) If the Coding Rate at the First Transmission Time is Low and a Redundant Bit at the Retransmission Time does not Exist

If the coding rate at the first transmission time is low, an error occurs and a redundant bit to be retransmitted does not exist. In such a case, retransmission data is transmitted so that Chase synthesis can be performed.

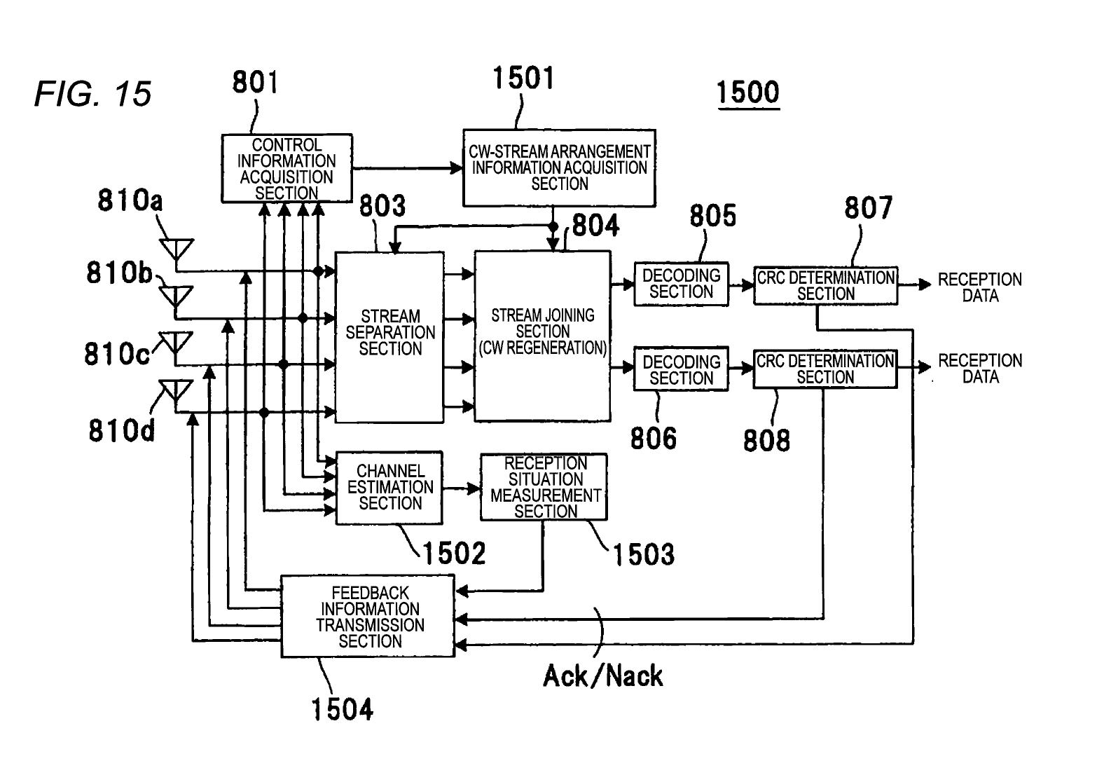

Next, a specific configuration example of the wireless communication apparatus according to the second embodiment is shown. FIG. 15 is a block diagram to show the configuration of the reception apparatus of the second embodiment. A reception apparatus 1500 is made up of a control information acquisition section 801, a CW-stream arrangement information acquisition section 1501, a channel estimation section 1502, a reception situation measurement section 1503, a stream separation section 803, a stream joining section 804, decoding sections 805 and 806, CRC determination sections 807 and 808, a feedback information transmission section 1504, and a plurality of antennas 810a, 810b, 810c, and 810d. Here, components different from those of the first embodiment described above will be discussed and components similar to those of the first embodiment are denoted by the same reference numerals and will not be discussed again.

The reception apparatus 1500 of the second embodiment differs from that of the first embodiment shown in FIG. 8 in that the channel estimation section 1502 and the reception situation measurement section 1503 are added and the CW-stream arrangement information acquisition section 1501 is provided in place of the CW-stream arrangement determination section.

The channel estimation section 1502 performs channel estimation of each stream using a pilot signal transmitted from the transmission apparatus of the communicating station. The reception situation measurement section 1503 measures the reception situation of each transmission codeword using the channel estimation value provided by the channel estimation section 1502. Here, as the reception situation, SINR (Signal to Interference and Noise Raito) measurement value, etc., can be used.

The feedback information transmission section 1504 performs transmission processing for feeding back the reception situation of each codeword measured by the reception situation measurement section 1503 to the transmission apparatus as CQI in addition to Ack/Nack information from the CRC determination sections 807 and 808 and any other feedback information.

The CW-stream arrangement information acquisition section 1501 acquires CW-stream arrangement information reported in the control information transmitted from the transmission apparatus and sends the CW-stream arrangement information to the stream separation section 803 and the stream joining section 804.

In the configuration described above, the CW-stream arrangement information acquisition section 1501 implements the function of a codeword-stream arrangement determination section. The channel estimation section 1502 and the reception situation measurement section 1503 implement the function of a reception quality determination section.

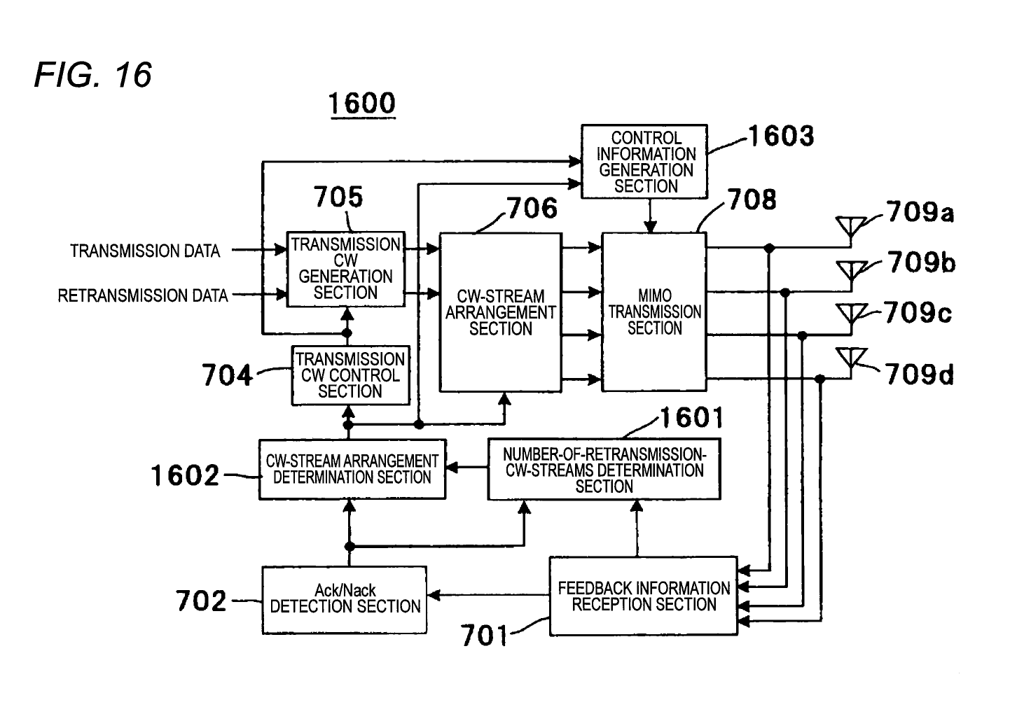

FIG. 16 is a block diagram to show the configuration of the transmission apparatus of the second embodiment. A transmission apparatus 1500 is made up of a feedback reception information section 701, an Ack/Nack detection section 702, a number-of-retransmission-CW-streams determination section 1601, a CW-stream arrangement determination section 1602, a transmission CW control section 704, a transmission CW generation section 705, a CW-stream arrangement section 706, a control information generation section 1603, an MIMO transmission section 708, and a plurality of antennas 709a, 709b, 709c, and 709d. Here, components different from those of the first embodiment described above will be discussed and components similar to those of the first embodiment are denoted by the same reference numerals and will not be discussed again.

The transmission apparatus 1600 of the second embodiment differs from that of the first embodiment shown in FIG. 7 in that the number-of-retransmission-CW-streams determination section 1601 is added.

The number-of-retransmission-CW-streams determination section 1601 determines the number of streams of retransmission codeword where Nack occurs based on the CQI of each codeword fed back from the reception apparatus of the communicating station and Nack information detected by the Ack/Nack detection section 702. As a specific determination method, the previously fed-back CQI is held and is compared with the current fed-back CQI and the number of transmission streams of retransmission codeword is determined using a number-of-transmission-streams determination table as in FIG. 11 described above. The determined number of transmission streams of retransmission codeword is sent to the CW-stream arrangement determination section 1602.

The CW-stream arrangement determination section 1602 determines the CW-stream arrangement according to the Ack/Nack information of each codeword and the error state of retransmission codeword. For example, the CW-stream arrangement in the CW-stream arrangement table as in FIG. 13 is determined using the CW-stream arrangement determination table as in FIG. 14 described above. The control information generation section 1603 adds CW-stream arrangement information to MCS information and retransmission control information of transmission codeword and generates control information.

In the configuration described above, the number-of-retransmission-CW-streams determination section 1601 implements the function of a number-of-retransmission-codeword-streams determination section and the number-of-retransmission-CW-streams determination section 1601 and the CW-stream arrangement determination section 1602 implement the function of a codeword-stream arrangement determination section.

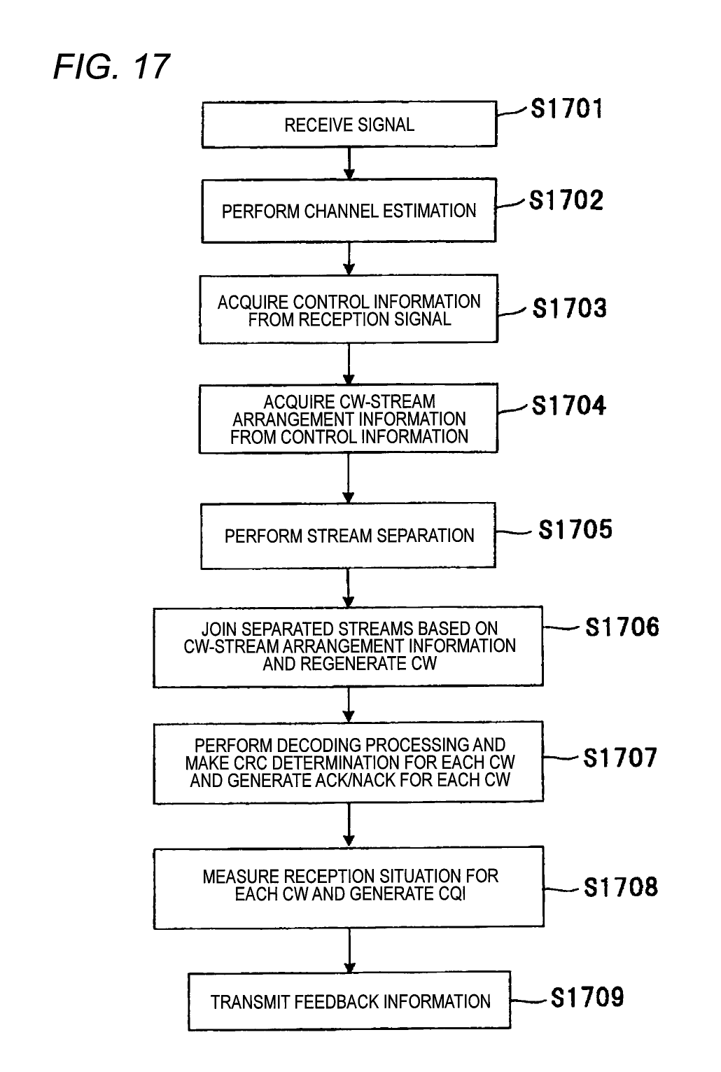

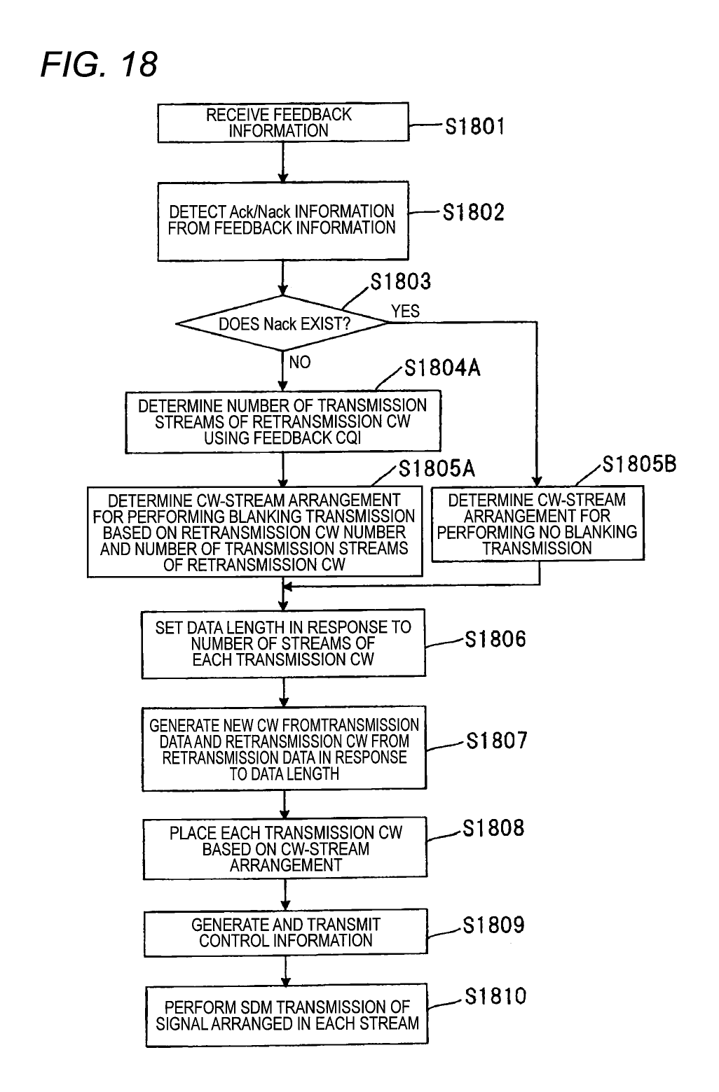

Next, a processing flow in the wireless communication apparatus of the second embodiment will be discussed. FIG. 17 is a chart to show a processing flow of the reception apparatus of the second embodiment, and FIG. 18 is a chart to show a processing flow of the transmission apparatus of the second embodiment. Here, the characteristic processing of the embodiment will be discussed and general processing for conducting MCW communications is omitted. In the examples in the processing flow, the number of transmission streams is four and the number of transmission codewords is two.

To begin with, the processing flow of the reception apparatus 1500 will be discussed in order with FIG. 17.

(Step S1701) As at step S1001 in the first embodiment, a signal transmitted from the transmission apparatus 1600 is received through the antennas 810a, 810b, 810c, and 810d.

(Step S1702) The channel estimation section 1502 extracts a pilot signal from the signal received at step S1701 and performs channel estimation.

(Step S1703) As at step S1002 in the first embodiment, the control information acquisition section 801 acquires control information from the reception signal received at step S1701.

(Step S1704) The CW-stream arrangement information acquisition section 1501 acquires CW-stream arrangement information from the control information acquired at step S1703.

(Steps S1705 to S1707) Processing similar to that at steps S1005 to S1007 in the first embodiment is performed. That is, the stream separation section 803 performs stream separation of the reception signal based on the acquired CW-stream arrangement information, and the stream joining section 804 joins the streams separated based on the CW-stream arrangement information and regenerates transmission codeword. For each regenerated codeword, the decoding sections 805 and 806 perform decoding processing and the CRC determination sections 807 and 808 make error determination, and Ack/Nack information is generated for each codeword based on the error determination result.

(Step S1708) The reception situation measurement section 1503 measures the reception situation of each codeword using the channel estimation value estimated at step S1702. As the reception situation, reception SINR, etc., is used. CQI is generated from the measured reception situation.

(Step S1709) The feedback information transmission section 1504 feeds back the CQI generated at step S1708 to the transmission apparatus as feedback information in addition to the Ack/Nack information and any other feedback information.

The processing flow of the transmission apparatus 1600 will be discussed in order with FIG. 18.

(Steps S1801 to S1803) Processing similar to that at steps S901 to S903 in the first embodiment is performed. That is, the feedback reception information section 701 receives feedback information from the reception apparatus 1500 and the Ack/Nack detection section 702 detects Ack/Nack information from the received feedback information and determines whether or not Nack exists, namely, retransmission occurs. If Nack exists, the process goes to step S1804A; if Nack does not exist, the process goes to step S1805B.

(Step S1804A) If Nack exists, the number-of-retransmission-CW-streams determination section 1601 acquires the CQI of each codeword from the feedback information acquired at step S1801 and determines the number of streams in retransmission codeword where Nack information is detected at step S1802.

(Step S1805A) The CW-stream arrangement determination section 1602 determines CW-stream arrangement when blanking transmission is performed based on the number of streams of retransmission codeword determined at step S1804A and the retransmission codeword number.

(Step S1805B) If Nack does not exist, the CW-stream arrangement determination section 1602 determines CW-stream arrangement when blanking transmission is not performed.

(Steps S1806 to S1810) Processing similar to that at steps S905 to S909 in the first embodiment is performed. That is, the transmission CW control section 704 sets the data length of each transmission codeword in response to the number of streams of each transmission codeword based on the determined CW-stream arrangement. The transmission CW generation section 705 generates each transmission codeword in response to the setup data length. The CW-stream arrangement section 706 places each generated transmission codeword in streams based on the determined CW-stream arrangement. The control information generation section 707 generates and transmits control information of each codeword and the MIMO transmission section 708 performs MIMO transmission (SDM transmission) of transmission signal from each arranged stream through the antennas 709a, 709b, 709c, and 709d.

Thus, in the second embodiment, the error factor is determined according to the reception situation at the retransmission occurrence time and the number of streams required for retransmission codeword is determined. Stream blanking is performed in a plurality of streams per codeword and when retransmission occurs, the operation of decreasing the number transmission streams is performed without decreasing the number of transmission codewords. Accordingly, while the advantage of the first embodiment is provided, the number of data pieces required for retransmission codeword is controlled, whereby further lowering of the frequency use efficiency can be prevented.

As modified examples of the second embodiment, the following configuration can also be named as a variation of processing when Nack occurs at the same time in a plurality of codewords:

In a first modified example, the error state is determined for each codeword where Nack occurs, and a stream is assigned in response to the error state. For example, retransmission data of the codeword in bad reception situation, of a plurality of retransmission codewords is transmitted in two streams and retransmission data of the codeword in good reception situation is transmitted in one stream. Accordingly, if retransmission occurs at the same time in a plurality of codewords, the blanking advantage can be provided and the number of transmission data pieces can be controlled in response to the reception situation of each codeword, so that retransmission is resolved early and lowering of the frequency efficiency can be prevented.

In a second modified example, the error state is determined for each codeword where Nack occurs, and the number-of-data-pieces ratio between codewords is found in response to the error state. The number of transmission data pieces when one stream is blanked is found and retransmission data of a plurality of codewords is arranged. Accordingly, if retransmission occurs at the same time in a plurality of codewords, the blanking advantage can be provided and the number of transmission data pieces can be controlled in response to the reception situation of each codeword, so that retransmission is resolved early and lowering of the frequency efficiency can be prevented.

### Third Embodiment

Next, as a third embodiment, a configuration example of a wireless communication apparatus for performing processing of adaptively controlling transmission streams of retransmission codeword and new codeword using stream ordering (stream ordering) will be discussed. Here, stream ordering is described as ordering, but may be called ranking.

In MCW, streams are ordered according to the quality, whereby a blanking stream and a stream for transmitting each codeword can be selected appropriately. Using the stream ordering, blanking of a stream having good quality can be circumvented, so that frequency efficiency can be improved.

From the viewpoint described above, in the third embodiment, in a reception apparatus, streams are ordered according to the quality and ordering information is fed back to a transmission apparatus. In the transmission apparatus, a blanking stream and a stream for transmitting retransmission codeword, new codeword are determined using the stream ordering information.

At this time, for example, in the receiving party, a stream having low quality is blanked, whereby the use efficiency of transmission power improves as compared with blanking of a stream having good quality. Thus, it is desirable that the lowest-rank stream in ordering should be blanked. Retransmission codeword is transmitted from a stream having good quality, whereby it can be reliably transmitted. Thus, to early resolve retransmission codeword, retransmission codeword is transmitted from the highest-rank stream or the highest-rank stream and the second-rank stream and new codeword is transmitted from the remaining streams. If a delay caused by retransmission is allowed to some extent and new codeword takes precedence over retransmission codeword, new codeword is transmitted from the highest-rank stream or the highest-rank stream and the second-rank stream and retransmission codeword is transmitted from the remaining streams.

Next, a specific method of stream blanking in the third embodiment is illustrated. Here, as in the first embodiment, a system wherein the number of transmission antennas is four, the number of reception antennas is four, the number of transmission codewords is two, and each codeword is transmitted in two streams is assumed and an example wherein two codewords are transmitted in four streams at the first transmission time at which no retransmission occurs is shown.

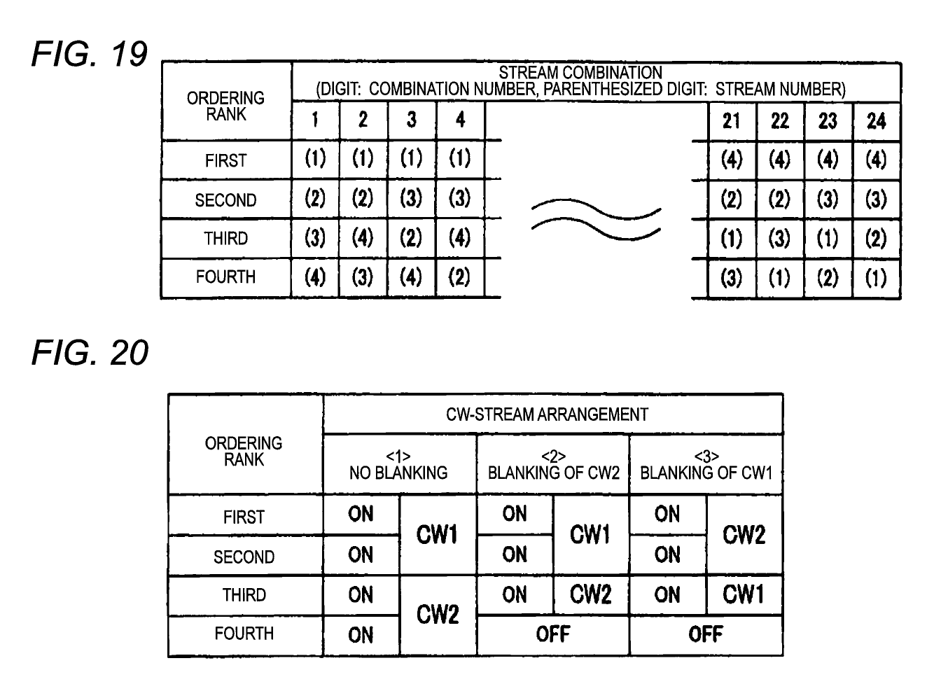

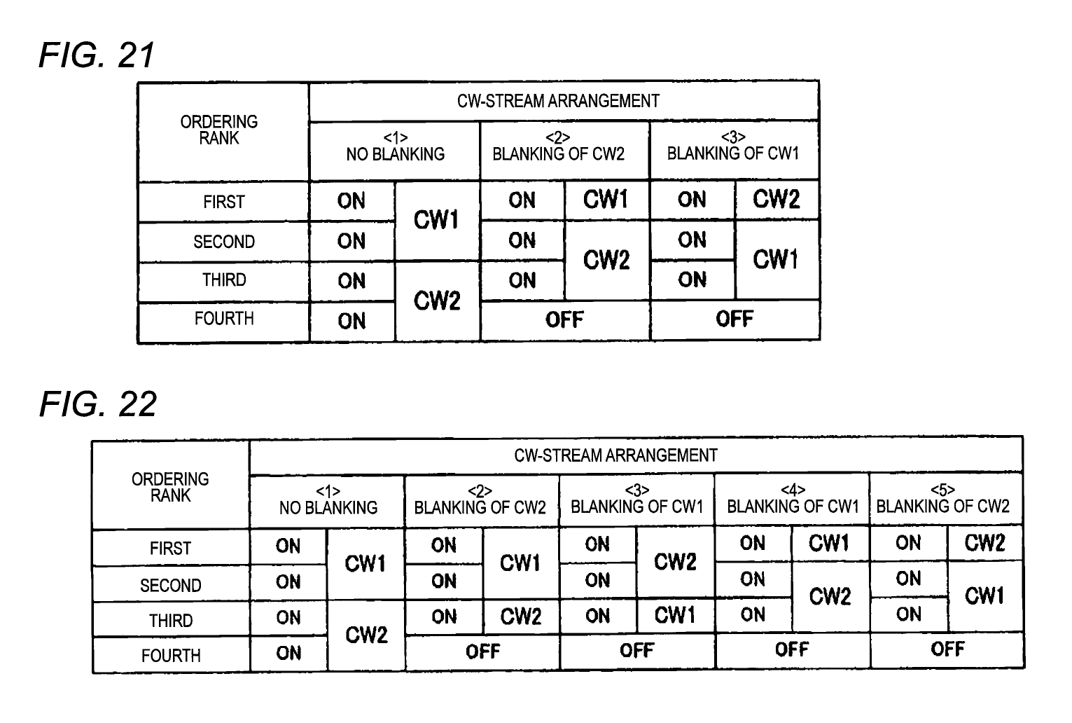

FIG. 19 is a drawing to show an example of a stream ordering information table. FIG. 20 is a drawing to show a first example of a CW-stream arrangement table to show the arrangement relationship between codewords and streams (high-rank two streams, low-rank one stream), and FIG. 21 is a drawing to show a second example of the CW-stream arrangement table to show the arrangement relationship between codewords and streams (high-rank one stream, low-rank two streams).

In the embodiment, both transmission and reception possess the stream ordering information table as shown in FIG. 19 and the combination number is selected based on the ordering result in the reception apparatus and is fed back to the transmission apparatus. In each stream combination shown in FIG. 19, digit 1, 2, . . . represents the combination number and parenthesized digit (1), (2), . . . represents each stream number.

As the first example, both transmission and reception possess the CW-stream arrangement table as in FIG. 20 and when retransmission codeword does not exist, blanking does not exist and <1> CW-stream arrangement is used; when retransmission codeword occurs, <2> or <3> CW-stream arrangement is used depending on the codeword to be blanked. That is, CW-stream arrangement set in combination of high-rank two streams, low-rank one stream is applied in response to stream ordering. Accordingly, it is made possible to realize blanking with high-rank two streams, low-rank one stream assigned to each codeword at the retransmission time.

As the second example, both transmission and reception possess the CW-stream arrangement table as in FIG. 21 and when retransmission codeword does not exist, blanking does not exist and <1> CW-stream arrangement is used; when retransmission codeword occurs, <2> or <3> CW-stream arrangement can also be used depending on the codeword to be blanked. That is, CW-stream arrangement set in combination of high-rank one stream, low-rank two streams is applied in response to stream ordering. Accordingly, it is made possible to realize blanking with high-rank one stream, low-rank two streams assigned to each codeword at the retransmission time.

As in the first embodiment, selection as to which of the CW-stream arrangement tables in FIG. 20 and FIG. 21 may be determined at the communication start time or may be changed in a comparatively long period for a wireless frame of a communication line. At the time, notification as to which table is selected is provided so that the same CW-stream arrangement table can be used in both transmission and reception. The transmitting party may determine the table and may communicate to the receiving party or vice versa. If there is a room for the control line for providing notification for each wireless frame, the table may be changed in the period of the wireless frame.

In the third embodiment, as in the second embodiment, the number of streams of retransmission codeword can also be controlled adaptively. FIG. 22 is a drawing to show a third example of the CW-stream arrangement table to show the arrangement relationship between codewords and streams (to adaptively control the number of streams of retransmission codeword). In this case, any of <1> to <5> CW-stream arrangements is selected using the CW-stream arrangement table as shown in FIG. 22, whereby blanking responsive to the number of streams required for retransmission codeword and the stream ordering can be realized.

In the embodiment, the stream ordering information is represented by combinations of all streams as in FIG. 19. However, the invention is not limited to the mode. A method of sending only important information as the ordering information may be adopted. For example, the stream number of the lowest-rank stream is only sent, whereby the stream to be blanked can be limited. In this case, it is made possible to decrease the information amount of feedback information. In addition to the lowest-rank stream, the highest-rank stream is only added, whereby the stream to be blanked and the stream having the best quality can be determined, so that it is made possible to place retransmission codeword and terminate retransmission early.

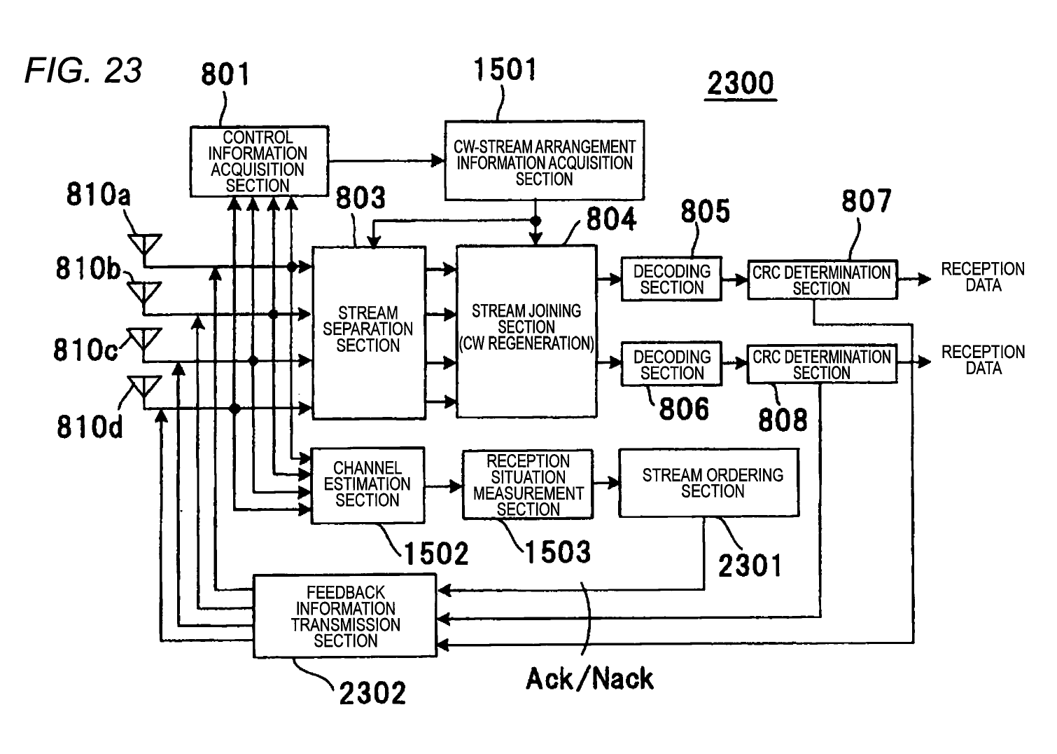

Next, a specific configuration example of the wireless communication apparatus according to the third embodiment is shown. FIG. 23 is a block diagram to show the configuration of the reception apparatus of the third embodiment. A reception apparatus 2300 is made up of a control information acquisition section 801, a CW-stream arrangement information acquisition section 1501, a channel estimation section 1502, a reception situation measurement section 1503, a stream ordering section 2301, a stream separation section 803, a stream joining section 804, decoding sections 805 and 806, CRC determination sections 807 and 808, a feedback information transmission section 2302, and a plurality of antennas 810a, 810b, 810c, and 810d. Here, components different from those of the first and second embodiments described above will be discussed and components similar to those of the first and second embodiments are denoted by the same reference numerals and will not be discussed again.

The reception apparatus 2300 of the third embodiment differs from that of the second embodiment shown in FIG. 15 in that the stream ordering section 2301 is added. The stream ordering section 2301 orders a plurality of streams in response to the reception situation (reception quality) measured by the reception situation measurement section 1503.

The feedback information transmission section 2302 performs transmission processing for feeding back the stream ordering information determined by the stream ordering section 2301 to the transmission apparatus in addition to Ack/Nack information from the CRC determination sections 807 and 808, the CQI indicating the reception situation of each codeword measured by the reception situation measurement section 1503, and any other feedback information.

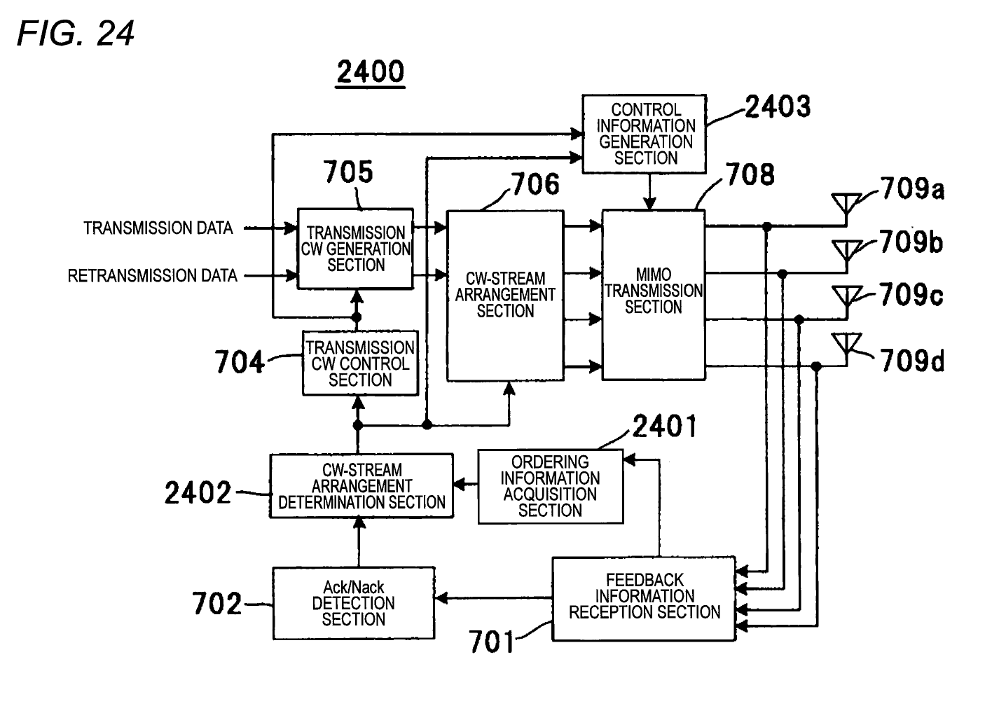

FIG. 24 is a block diagram to show the configuration of the transmission apparatus of the third embodiment. A transmission apparatus 2400 is made up of a feedback reception information section 701, an Ack/Nack detection section 702, an ordering information acquisition section 2401, a CW-stream arrangement determination section 2402, a transmission CW control section 704, a transmission CW generation section 705, a CW-stream arrangement section 706, a control information generation section 2403, an MIMO transmission section 708, and a plurality of antennas 709a, 709b, 709c, and 709d. Here, components different from those of the first and second embodiments described above will be discussed and components similar to those of the first and second embodiments are denoted by the same reference numerals and will not be discussed again.

The transmission apparatus 2400 of the third embodiment differs from that of the second embodiment shown in FIG. 16 in that the ordering information acquisition section 2401 is added in place of the number-of-retransmission-CW-streams determination section 1601. The ordering information acquisition section 2401 acquires the stream ordering information fed back from the reception apparatus of the communicating station according to the feedback information.

The CW-stream arrangement determination section 2402 determines CW-stream arrangement based on the Ack/Nack information of each codeword and the stream ordering information. For example, the CW-stream arrangement is determined using the CW-stream arrangement table as in FIG. 20 or FIG. 21. The CW-stream arrangement information to be output contains the stream ordering information as in FIG. 19 described above. The control information generation section 2403 adds the CW-stream arrangement information containing the stream ordering information to the MCS information and retransmission control information of transmission codeword and generates control information.

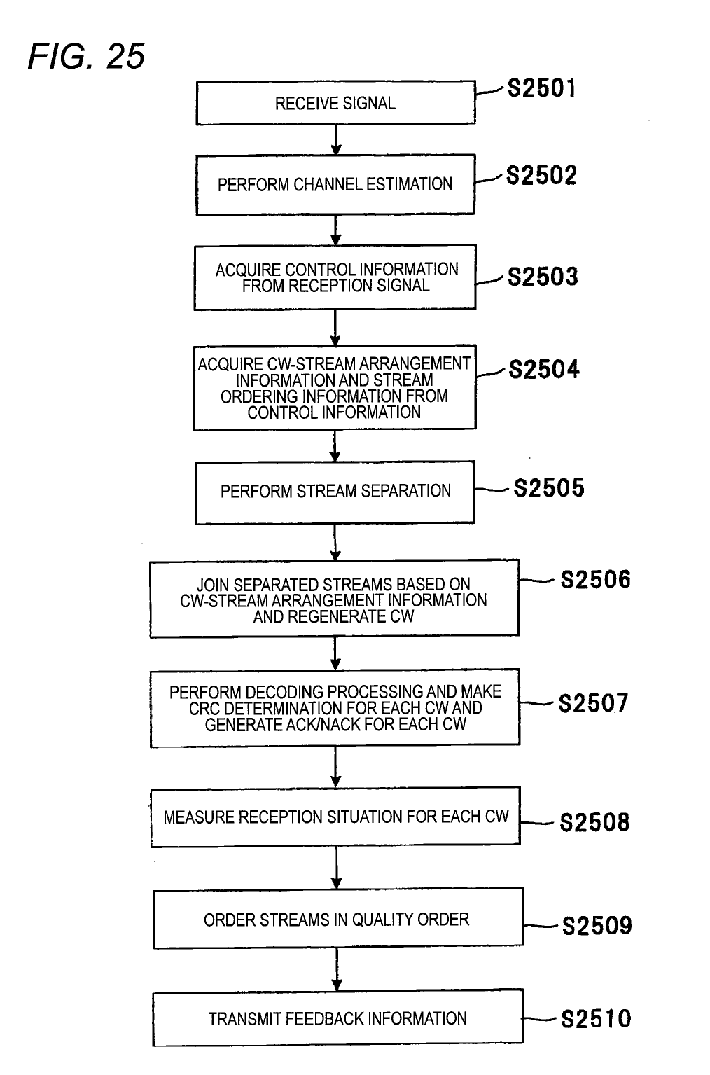

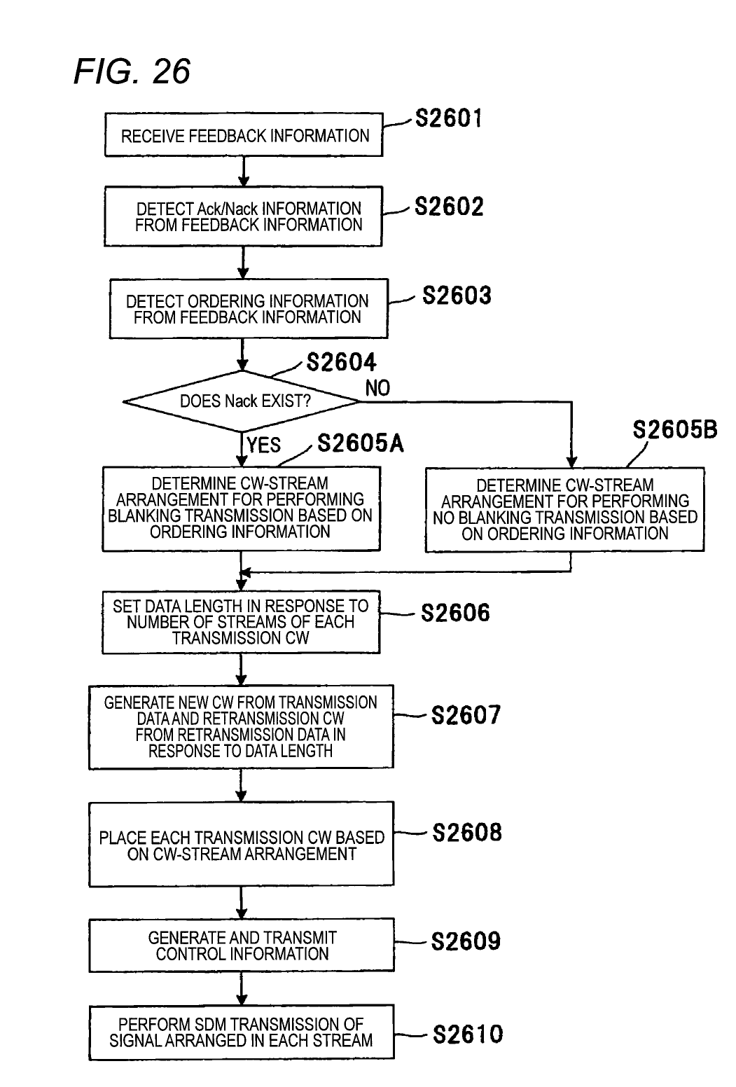

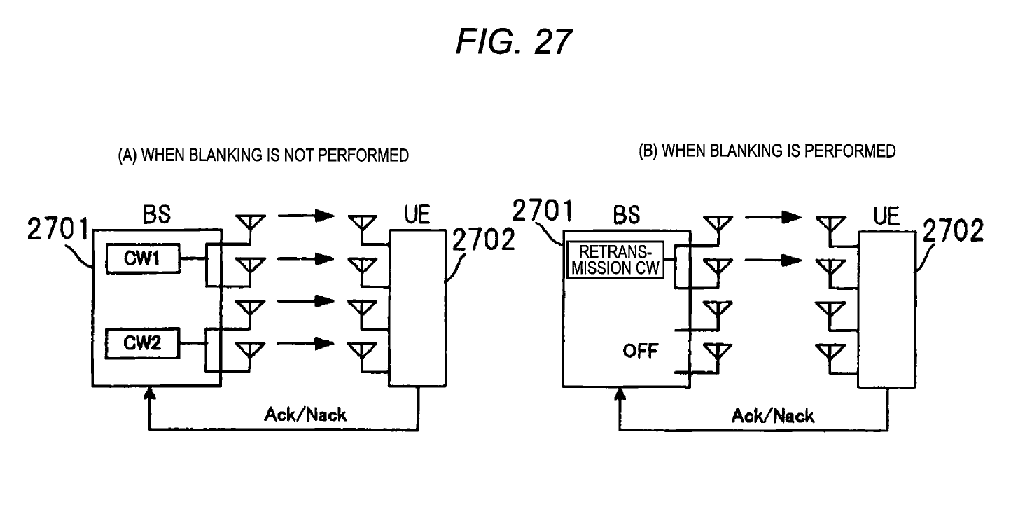

Next, a processing flow in the wireless communication apparatus of the third embodiment will be discussed. FIG. 25 is a chart to show a processing flow of the reception apparatus of the third embodiment, and FIG. 26 is a chart to show a processing flow of the transmission apparatus of the third embodiment. Here, the characteristic processing of the embodiment will be discussed and general processing for conducting MCW communications is omitted. In the examples in the processing flow, the number of transmission streams is four and the number of transmission codewords is two.

To begin with, the processing flow of the reception apparatus 2300 will be discussed in order with FIG. 25.

(Steps S2501 to 2503) Processing similar to that at steps S1701 to S1703 in the second embodiment is performed. That is, a signal transmitted from the transmission apparatus 2400 is received through the antennas 810a, 810b, 810c, and 810d, the channel estimation section 1502 extracts a pilot signal from the received signal and performs channel estimation, and the control information acquisition section 801 acquires control information from the received reception signal.

(Step S2504) The CW-stream arrangement information acquisition section 1501 acquires CW-stream arrangement information and stream ordering information from the control information acquired at step S2503.

(Steps S2505 to S2507) Processing similar to that at steps S1705 to S1707 in the second embodiment is performed. That is, the stream separation section 803 performs stream separation of the reception signal based on the acquired CW-stream arrangement information, and the stream joining section 804 joins the streams separated based on the CW-stream arrangement information and regenerates transmission codeword. For each regenerated codeword, the decoding sections 805 and 806 perform decoding processing and the CRC determination sections 807 and 808 make error determination, and Ack/Nack information is generated for each codeword based on the error determination result.

(Step S2508) The reception situation measurement section 1503 measures the reception situation of each codeword using the channel estimation value estimated at step S2502. As the reception situation, reception SINR, etc., is used.

(Step S2509) The stream ordering section 2301 orders streams in the quality order based on the reception quality for each stream measured at step S2508.

(Step S2510) The feedback information transmission section 1504 generates feedback information containing the stream ordering information determined at step S2509 in addition to the Ack/Nack information and any other feedback information and feeds back to the transmission apparatus.

The processing flow of the transmission apparatus 2400 will be discussed in order with FIG. 26.

(Steps S2601 and S2602) Processing similar to that at steps S1801 and S1802 in the second embodiment is performed. That is, the feedback reception information section 701 receives feedback information from the reception apparatus 2300 and the Ack/Nack detection section 702 detects Ack/Nack information from the received feedback information.

(Step S2603) The ordering information acquisition section 2401 acquires the stream ordering information from the feedback information received at step S2601.

(Step S2604) The Ack/Nack detection section 702 determines whether or not Nack exists, namely, retransmission occurs. If Nack exists, the process goes to step S2605A; if Nack does not exist, the process goes to step S2605B.

(Step S2605A) If Nack exists, the CW-stream arrangement determination section 2402 determines CW-stream arrangement for performing blanking transmission based on the stream ordering information acquired at step S2603.

(Step S2605B) If Nack does not exist, the CW-stream arrangement determination section 2402 determines CW-stream arrangement for performing no blanking transmission based on the stream ordering information acquired at step S2603.

(Steps S2606 to S2610) Processing similar to that at steps S1806 to S1810 in the second embodiment is performed. That is, the transmission CW control section 704 sets the data length of each transmission codeword in response to the number of streams of each transmission codeword based on the determined CW-stream arrangement, and the transmission CW generation section 705 generates each transmission codeword in response to the setup data length. The CW-stream arrangement section 706 places each generated transmission codeword in streams based on the determined CW-stream arrangement. The control information generation section 707 generates and transmits control information of each codeword and the MIMO transmission section 708 performs MIMO transmission (SDM transmission) of transmission signal from each arranged stream through the antennas 709a, 709b, 709c, and 709d.

Thus, in the third embodiment, stream ordering based on the reception quality is used and while transmission streams of retransmission codeword and new codeword are adaptively controlled, stream blanking is performed in a plurality of streams per codeword and when retransmission occurs, the operation of decreasing the number transmission streams is performed without decreasing the number of transmission codewords. Accordingly, a blanking stream and a stream for transmitting each codeword can be selected from fitted streams in response to the reception situation, so that the preventing effect of lowering of the frequency efficiency can be further improved.

It is to be understood that the invention is not limited to the items shown in the embodiments described above and the invention is also intended for those skilled in the art to make modifications and application based on the Description of the invention and well-known arts and the modifications and the application are contained in the scope to seek protection.

As the number of streams and the number of codewords, the case where the number of streams is four or eight and the number of codewords is two is illustrated, but the invention is not limited to it and can be applied in any numbers.

The embodiments have been described by taking the case where the invention is embodied by hardware as an example, but the invention can also be implemented by software.

Each of the function blocks used in the description of the embodiments is implemented typically as an LSI of an integrated circuit. The function blocks may be put individually into one chip or may be put into one chip so as to contain some or all. Here, the integrated circuit is an LSI, but may be called an IC, a system LSI, a super LSI, or an ultra LSI depending on the difference in integration degree.

The technique of putting into an integrated circuit is not limited to an LSI and it may be implemented as a dedicated circuit or a general-purpose processor. An FPGA (Field Programmable Gate Array) that can be programmed after LSI is manufactured or a reconfigurable processor wherein connection and setting of circuit cells in LSI can be reconfigured may be used.

Further, if a technology of putting into an integrated circuit replacing LSI appears with the progress of the semiconductor technology or another deriving technology, the function blocks may be integrated using the technology, of course. There can be a possibility of applying a biotechnology, etc.

This application is based on Japanese Patent Application (No. 2007-252362) filed on Sep. 27, 2007, which is incorporated herein by reference.

### INDUSTRIAL APPLICABILITY

The invention has the advantage that it can prevent lowering of the frequency use efficiency and throughput while providing the blanking advantage at the retransmission time in MCW using a plurality of streams per codeword, and is useful in a wireless communication apparatus, a wireless communication system, a wireless communication method, and the like that can be applied to MIMO, etc., for conducting communications using a plurality of antennas.

1. A wireless communication apparatus for using a plurality of streams per codeword and performing data transmission according to a plurality of codewords, the wireless communication apparatus comprising:
a feedback information reception section that receives feedback information from a communicating station;
an Ack/Nack detection section that detects Ack/Nack information corresponding to a reception result of the plurality of codewords contained in the feedback information;
a codeword-stream arrangement determination section that determines an arrangement of the codewords and the streams so as to decrease the number of streams while keeping the number of codewords in response to the presence or absence of Nack of the Ack/Nack information when retransmission occurs; and
a transmission processing section that performs a transmission processing in response to the arrangement of the codewords and the streams.

2. The wireless communication apparatus according to claim 1, wherein the codeword-stream arrangement determination section decreases the number of streams of a new codeword in the arrangement of the number of streams.

3. The wireless communication apparatus according to claim 1, wherein the codeword-stream arrangement determination section decreases the number of streams of a retransmission codeword in the arrangement of the number of streams.

4. The wireless communication apparatus according to claim 1, wherein the codeword-stream arrangement determination section has a table indicating an arrangement relationship between the codewords and the streams in each retransmission situation together with the communicating station and determines the arrangement of the codewords and the streams based on the table.

5. The wireless communication apparatus according to claim 1, wherein the codeword-stream arrangement determination section determines the number of streams of retransmission codeword in response to an error factor of codeword where the retransmission occurs.

6. The wireless communication apparatus according to claim 5, comprising:
a number-of-retransmission-codeword-streams determination section that determines the number of streams of retransmission codeword in response to an error factor of the codeword when the retransmission occurs.

7. The wireless communication apparatus according to claim 6, wherein the number-of-retransmission-codeword-streams determination section determines an error occurring at random or an error caused by degradation in reception situation as the error factor based on reception quality information contained in the feedback information and determines the number of streams of the retransmission codeword.

8. The wireless communication apparatus according to claim 1, wherein the codeword-stream arrangement determination section determines an arrangement of a transmission stream of each codeword and a blanking stream for performing blanking with transmission OFF in response to a rank of ordering based on reception quality of the plurality of streams.

9. The wireless communication apparatus according to claim 8, comprising:
an ordering information acquisition section that acquires ordering information representing the rank of ordering of the plurality of streams,
wherein the codeword-stream arrangement determination section determines the arrangement of the codewords and the streams based on the ordering information.

10. The wireless communication apparatus according to claim 1, wherein the codeword-stream arrangement determination section determines the arrangement of a transmission stream of each codeword and a blanking stream for performing blanking with transmission OFF in response to an error factor of the codeword where the retransmission occurs and a rank of ordering based on reception quality of the plurality of streams.

11. The wireless communication apparatus according to claim 10, comprising:
a number-of-retransmission-codeword-streams determination section that determines the number of streams of retransmission codeword in response to the error factor of the codeword when the retransmission occurs; and
an ordering information acquisition section that acquires ordering information representing the rank of ordering of the plurality of streams,
wherein the codeword-stream arrangement determination section determines the arrangement of the codewords and the streams based on the ordering information and the number of streams of retransmission codeword which is determined in response to the error factor.

12. A wireless communication apparatus for using a plurality of streams per codeword and performing data transmission according to a plurality of codewords, the wireless communication apparatus comprising:
a control information acquisition section that acquires control information from a communicating station;
a codeword-stream arrangement determination section that determines an arrangement of the codewords and the streams so as to decrease the number of streams while keeping the number of codewords based on the control information when retransmission occurs;
a reception processing section that performs a reception processing in response to the arrangement of the codewords and the streams; and
a feedback information transmission section that transmits feedback information having a response signal corresponding to a reception result of the plurality of codewords.

13. The wireless communication apparatus according to claim 12, wherein the codeword-stream arrangement determination section decreases the number of streams of a new codeword in the arrangement of the number of streams.

14. The wireless communication apparatus according to claim 12, wherein the codeword-stream arrangement determination section decreases the number of streams of a retransmission codeword in the arrangement of the number of streams.

15. The wireless communication apparatus according to claim 12, wherein the codeword-stream arrangement determination section has a table indicating an arrangement relationship between the codewords and the streams in each retransmission situation together with the communicating station and determines the arrangement of the codewords and the streams based on the table.

16. The wireless communication apparatus according to claim 12, wherein the codeword-stream arrangement determination section acquires codeword-stream arrangement information contained in the control information from the communicating station and determines the arrangement of the codewords and the streams based on the codeword-stream arrangement information.

17. The wireless communication apparatus according to claim 12, wherein the codeword-stream arrangement determination section determines the number of streams of retransmission codeword in response to an error factor of codeword where the retransmission occurs.

18. The wireless communication apparatus according to claim 17, comprising:
a reception quality determination section that determines a reception quality of the codeword received by the reception processing section,
wherein the feedback information transmission section transmits feedback information having the reception quality; and
wherein the codeword-stream arrangement determination section acquires codeword-stream arrangement information contained in the control information from the communicating station and determines the arrangement of the codewords and the streams by the number of streams of retransmission codeword determined in response to the error factor based on the reception quality.

19. The wireless communication apparatus according to claim 12, wherein the codeword-stream arrangement determination section determines an arrangement of a transmission stream of each codeword and a blanking stream for performing blanking with transmission OFF in response to a rank of ordering based on reception quality of the plurality of streams.

20. The wireless communication apparatus according to claim 19, comprising:
a stream ordering section that orders the plurality of streams based on reception quality of the codeword received by the reception processing section,
wherein the feedback information transmission section transmits the feedback information containing the stream ordering information; and
wherein the codeword-stream arrangement determination section acquires codeword-stream arrangement information contained in the control information from the communicating station and determines the arrangement of the codewords and the streams by the transmission stream of each codeword determined in response to the rank of the ordering and the blanking stream.

21. The wireless communication apparatus according to claim 12, wherein the codeword-stream arrangement determination section determines the arrangement of a transmission stream of each codeword and a blanking stream for performing blanking with transmission OFF in response to an error factor of the codeword where the retransmission occurs and a rank of ordering based on reception quality of the plurality of streams.

22. The wireless communication apparatus according to claim 21, comprising:
a reception quality determination section that determines a reception quality of the codeword received by the reception processing section; and
a stream ordering section that orders the plurality of streams based on the reception quality,
wherein the feedback information transmission section transmits the feedback information having the reception quality and the stream ordering information; and
wherein the codeword-stream arrangement determination section acquires codeword-stream arrangement information contained in the control information from the communicating station and determines the arrangement of the codewords and the streams by the number of streams of retransmission codeword determined in response to the error factor based on the reception quality and a transmission stream of each codeword determined in response to the rank of the ordering and a blanking stream.

23. (canceled)

24. (canceled)

25. (canceled)

26. A wireless communication method, comprising:
performing data transmission according to a plurality of codewords by using a plurality of streams per codeword; and
determining an arrangement of codewords and streams so as to decrease the number of streams while keeping the number of codewords when retransmission occurs in the codeword.
